(19) United States
(12) Patent Application Publication
(10) Pub. No.: US 2008/0313632 A1
(43) Pub. Date: Dec. 18, 2008

(54) METHODS, DEVICES, AND PRODUCTS FOR PROVIDING ACCESS TO SYSTEM-ADMINISTRATION FUNCTIONS OF A COMPUTER OR RELATED RESOURCES

(76) Inventors: Apurva Kumar, Cupertino, CA (US); Taras Shkvarchuk, Cupertino, CA (US); Srinivas N. Nithyanandam, Cupertino, CA (US); Joseph J. Martinka, Cupertino, CA (US); Basavaraj Y. Narthi, Cupertino, CA (US); Samuel Seung-Keun Carl, Cupertino, CA (US); Rostislav Rost Shevtsov, Cupertino, CA (US); David J. Roman, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/762,601

(22) Filed: Jun. 13, 2007

(51) Int. Cl. G06F 9/46

(52) U.S. Cl. 718/100

(57) ABSTRACT

Methods, devices, and products relating to displaying, in a shared user-interface object, system-administration-related content from a heterogeneous group of resources associated with a computing device and/or executing software operable to cause a system-administration task to be performed. In one embodiment, a user interface for a local program executing on a computing device is presented as a part of a Web page that is supplied from a remote server.

### BACKGROUND

A computer typically provides some mechanism by which system-administration tasks associated with the computer can be performed. Such system administration tasks include adding or remove applications, updating applications or the operating system, running diagnostic or maintenance software (such as hard drive utilities, virus scanners, and backup software). One common mechanism for providing access to some system-administration tasks is a “control panel,” such as the control panel that is included in the MICROSOFT WINDOWS family of operating systems. The control panel comprises a window in which a group of icons are displayed. In one common configuration (also referred to as the “Classic View”), each of the icons is associated with a particular system configuration, control, or diagnostic system applet. When a user “clicks on” on one of the icons, the associated system applet is executed so that the user can use the system configuration, control, or diagnostic functionality provided by that system applet to perform a particular task. However, the user must know when it is appropriate to carry out a particular task and which of the icons and associated system applets should be executed in order to carry out the task.

Some versions of the MICROSOFT WINDOWS operating system provide an alternative view for the control panel (also referred to as the “Category View” or “Task View”) in which categories of configuration, control, or diagnostic tasks are listed in the control panel. When a user clicks on one of the listed categories, a list of tasks that fall within that category is displayed within the control panel. When a user clicks on one of the listed tasks, an applet that is used to perform that clicked-on task is executed for the user. However, with such an approach, the user must still know when it is appropriate to execute such a task. That is, a user may be unaware that a particular task should be performed (for example, searching for operating system or application updates or patches or running virus detection and removal software). Moreover, before a user can use the control panel, the user must know how to access the control panel itself.

Furthermore, some applications and the operating system itself typically provide their own mechanisms to notify a user of information relating to the respective application or operating system. As a result of such an approach, the user can end up receiving many notifications, from different parts of the user interface and with varying degrees of urgency and relevance to the user. It is then up to the user to filter the messages, determine which messages should be acted upon, and to initiate the particular action.

### DRAWINGS

FIG. 1 is a high-level block diagram of one exemplary embodiment of a computer.

FIG. 2 is a high-level block diagram illustrating a heterogeneous group of resources with which the advisor software of FIG. 1 interacts.

FIGS. 3A-3H is one exemplary embodiment of a user interface suitable for use with the advisor software of FIG. 1.

FIG. 4 is a block diagram of one embodiment of advisor software.

FIG. 5 is a flow chart of one embodiment of a method of managing plug-ins suitable for use with the advisor software of FIG. 4.

FIG. 6 is a flow chart of one embodiment of a method of processing messages or other information received from a heterogeneous group of computing resources.

FIG. 7 is a flow chart of one embodiment of a method of displaying content in a user interface of the advisor.

FIG. 8 is a block diagram of one embodiment of providing an alternative user interface for the advisor.

FIGS. 9A-9C illustrates one example of the alternative user interface of FIG. 9.

FIGS. 10A-10C is a flow chart of one embodiment of a method of providing a user interface using an advisor portlet.

FIGS. 11A-11C is a flow chart of one embodiment of a method of providing a user interface using an advisor portlet.

Like reference numbers and designations in the various drawings indicate like elements.

### DETAILED DESCRIPTION

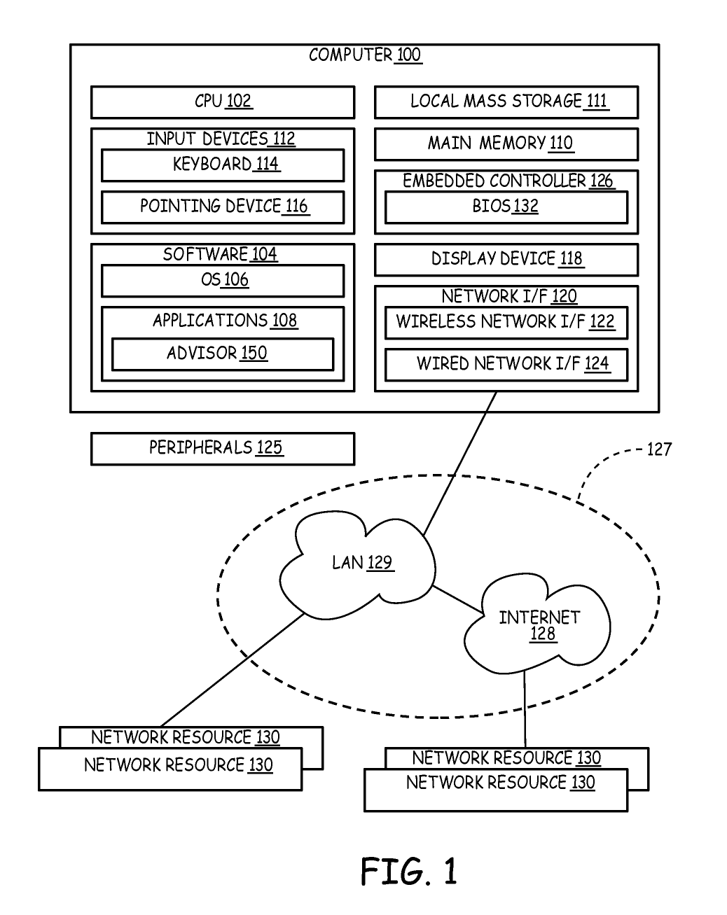

FIG. 1 is a high-level block diagram of one exemplary embodiment of a computing device 100. The computing device 100 can be implemented in various form factors and configurations, including for example, as a desktop computer, server computer, portable computer, and media center. Moreover, in other embodiments, the computing device 100 is embedded in (or otherwise incorporated in or communicatively coupled to) other electrical systems or devices. In the particular embodiment illustrated in FIG. 1, the computing device 100 comprises a computer (and is also referred to here as “computer” 100).

The computer 100 comprises at least one central processing unit (CPU) 102. The CPU 102 executes various items of software 104. In the embodiment shown in FIG. 1, the software 104 executed by the CPU 102 comprises an operating system (OS) 106 and one or more applications 108. The software 104 comprises program instructions that are embodied on one or more items of computer readable media (for example, a hard disk drive (or other mass storage device) local to the computer 100 and/or shared media such as a file server that is accessed over a network such as a local area network or wide area network such as the Internet). Typically, a portion of the software 104 executed by the CPU 102 and one or more data structures used by the software 104 during execution are stored in a main memory 110. Main memory 110 comprises, in one embodiment, any suitable form of random access memory (RAM) now known or later developed, such as dynamic random access memory (DRAM). In other embodiments, other types of memory are used.

The computer 100 comprises one or more local mass storage devices 111 such as hard disk drives, optical drives such as compact disc read-only memory (CDROM) drives and/or digital video disc (DVD) optical drives, USB flash drives, USB hard disk drives, and floppy drives. In some implementations, the data storage media and/or the read/write drive mechanism itself is removable (that is, can be removed from the computer 100). The computer 100 comprises appropriate buses and interfaces for communicatively coupling such local mass storage devices 110 to the computer 100 and (the components thereof).

One or more input devices 112 are communicatively coupled to the computer 100 by which a user is able to provide input to the computer 100. In the embodiment shown in FIG. 1, the input devices 112 comprise a keyboard 114 and a pointing device 116 (such as a mouse or a touch-pad). In some implementations of the embodiment shown in FIG. 1, the computer 100 includes one or more interfaces by which external input devices are communicatively coupled to the computer 100. Examples of such interfaces include dedicated keyboard/pointing device interfaces (for example, a PS/2 interface) and general-purpose input/output interfaces (for example, a universal serial port (USB) interface or BLUETOOTH interface). In other implementations (for example, where the computer 100 comprises a portable computer), the keyboard 114 and the pointing device 116 are integrated into the computer 100. In some of those implementations, a keyboard and/or pointing device external to the portable computer can also be communicatively coupled to the computer 100.

One or more display devices 118 are communicatively coupled to the computer 100 on or by which the computer 100 is able to display output for a user. In some other implementations of the embodiment shown in FIG. 1, the computer 100 comprises one or more interfaces by which one or more external display devices are communicatively coupled to the computer 100. In other implementations (for example, where the computer 100 comprises a portable computer), the display device 118 comprises a display that is integrated into the computer 100 (for example, an integrated liquid crystal display). In some of those implementations, the computer 100 also includes one or more interfaces by which one or more external display devices (for example, one or more external computer displays) can be communicatively coupled the computer 100.

The computer 100 also includes one or more network interfaces 120 for communicatively coupling the computer 100 (and the components thereof) to one or more networks or devices. In the particular embodiment shown in FIG. 1, the one or more network interfaces 120 are used to communicatively couple the computer 100 to one or more networks 127 (more specifically, a local area network 129 and the Internet 128) and any network resources 130 communicatively coupled thereto.

In the particular embodiment shown in FIG. 1, the computer 100 comprises a wireless network interface 122 and a wired network interface 124. The wireless network interface 122 is used to communicatively couple the computer 100 to, and send and receive data to and from, a network or other device using a wireless communication link (for example, a radio frequency or infra-red wireless communication link). In one implementation of such an embodiment, the wireless network interface 122 supports one or more of the Institute for Electrical and Electronics Engineers (IEEE) 802.11 or 802.16 family of standards and/or the BLUETOOTH personal area network standard. The wired network interface 124 is used to communicatively couple the computer 100 to, and send and receive data to and from, a network or other device using a wired communication link (for example, a copper-twisted pair cable or a fiber-optic cable). In one implementation of such an embodiment, the wired network interface 124 supports one or more of the IEEE 802.3 family of standards (also referred to here as the “ETHERNET” networking protocol). In other embodiments, other wireless or wired network protocols are supported.

In one implementation of the computer 100 shown in FIG. 1, one or more of the network interfaces 120 are removable by a user of the computer 100. In such an implementation, the computer 100 includes one or more slots into which such removable network interfaces are inserted (for example, a general-purpose slot such as a PC-CARD slot and/or a specially adapted slot such as a slot specially adapted to receive a network interface implemented as a MINI-PCI card). Moreover, in implementations of the computer 100 that include one or more general-purpose input/output interfaces (for example, USB interfaces), one or more of the network interfaces can be communicatively coupled to the computer via one or more of general-purpose input/output interfaces.

In the embodiment shown in FIG. 1, the computer 100 also comprises an embedded controller 126 that controls the operation of one or more of components in the computer 100. For example, in one implementation of such an embodiment, the embedded controller 126 implements functionality that enables the computer 100 to support the Advanced Configuration and Power Interface (ACPI) specification. In such an implementation, the embedded controller 126 interacts with configuration and/or power management interfaces provided by various components in the computer 100. In one implementation, the embedded controller 126 is implemented using a suitable programmable processor that executes appropriate software to carry out the processing described here as being performed by the embedded controller. Such software comprises program instructions that are stored (or otherwise embodied) on an appropriate storage medium or media (such as flash memory) from which at least a portion of the program instructions are read by the programmable processor for execution thereby. In such an implementation, the software executed by the embedded controller 126 comprises a basic input/output system (BIOS) 132 that provides an interface between the hardware of the computer 100 and the operating system 106 and other software 104 executed by the CPU 102. Various system configuration settings (also referred to here as a “BIOS settings”) that are used by the BIOS 132 are stored in a memory (for example, a non-volatile memory) used by the BIOS 132.

None, one, or more peripherals 125 are communicatively coupled to the computer 100 either directly (via direct wired or wireless communication link) or indirectly (for example, via a local area network). Examples of peripherals include imaging devices such as printers, copiers, scanners, fax machines, and multi-function devices that perform two or more of the foregoing functions, external storage devices such as external hard disk drives and external tape drives, and audio/video devices such as portable media players, speakers, headsets, and microphones. Other peripherals 125 are used in other embodiments.

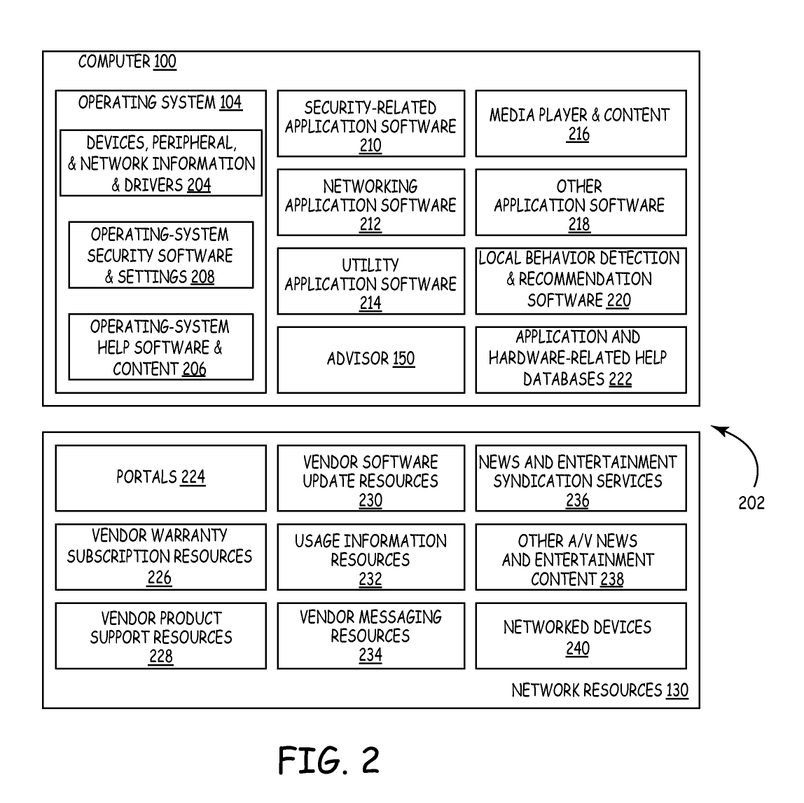

In the embodiment shown in FIG. 1, the software 104 comprises a central administrative program 150 (also referred to here as “advisor software” or just “advisor”). The advisor 150 provides an integrated interface by which a user of the computer 100 can view system-administration information and/or perform system-administration tasks relating to a heterogeneous group of computing resources. System administration tasks include tasks relating to the controlling, configuring, or diagnosing a condition and providing remediation related to such a resource including, for example, installing software updates, performing system backups, install or remove software, hardware, firmware, or drivers, checking resource utilization levels, checking for and removing virus or spyware, and diagnosing one or more problems with the computer 100. Moreover, in some embodiments, the advisor 150 is used to provide an integrated interface by which a user of the computer 100 can view system-administration information and/or perform system-administration tasks relating to one or more of the network resource 130 (for example, one or more networked devices that are communicatively coupled to the computer 100 via the local area network 129) instead of or in addition to doing the same for the computer 100 itself. One example of a heterogeneous group of computing resources 202 with which the advisor 150 interacts is shown in FIG. 2. The example shown in FIG. 2 is suitable for use with the embodiment of the advisor 150 described here in connection with FIG. 1 and FIGS. 3A-3H and 4-8.

In the example shown in FIG. 2, the heterogeneous group of computing resources 202 with which the advisor 150 interacts includes, for example, operating system software 104 (such as device, peripheral, and network information and drivers 204, operating-system security software and settings 208, and any operating-system help system and content 206), security-related application software 210 (including, for example, security applications such as virus and spyware checking software and firewall software), networking application software 212 (including, for example, Internet browsers), utility applications 212 (including, for example, backup software), media-player applications and content 214 (including, for example, audio and video players and content), other applications 216, local behavior detection and recommendation software and content 218, application and hardware-related help and support database 220, and network resources 130 related to any of the foregoing. The network resources 130 include, for example, portals 224 for displaying an alternate user interface for the advisor 150, vendor warranty subscription sites 226 for registering the user and/or the resources installed on or otherwise used by the computer 100, vendor product support resources 228 for providing product information such as support knowledge bases and frequently asked questions, vendor software update resources 230 providing software updates, usage information warehouses 232 for storing information about user interactions with the software installed on the computer (including, for example, the advisor 150 itself, the operating system 104, and other application software 106), vendor messaging resources 234 for providing vendor information such as advertising, price comparisons, and product recommendations, and news and entertainment syndication services 236 for supplying multimedia feeds (including entertainment and news feeds) such as really simple syndication (RSS) feeds for textual information and “podcasts,” and other audio and video entertainment and news content providers 238.

In the particular embodiment shown in FIG. 2, the network resources 130 also comprise networked devices 240 that are communicatively coupled to the computer 100 via the local area network 129. Examples of such network devices 240 include networked imaging devices (such as network printers, copiers, scanners, or multi-function devices), networked multimedia devices (such as televisions, stereos, or digital video or audio recorders), networked telephony equipment (such as internet protocol (IP) telephones), other computers, network storage devices, and networking devices (such as wired and wireless modems, gateways, routers, hubs, and switches). In some embodiments, the advisor 150 is used to provide an integrated interface by which a user of the computer 100 can view system-administration information and/or perform system-administration tasks relating to one or more of the networked devices 240 that are communicatively coupled to the computer 100 via the local area network 129, instead of or in addition to doing the same for the computer 100 itself. In such an embodiment, the advisor 150 is used, for example, to display alerts and other information about one or more of the networked devices 240 and to perform tasks related to one or more networked devices 240 such as updating software or firmware used by such networked devices 240 or buying content to be played using such networked devices 240.

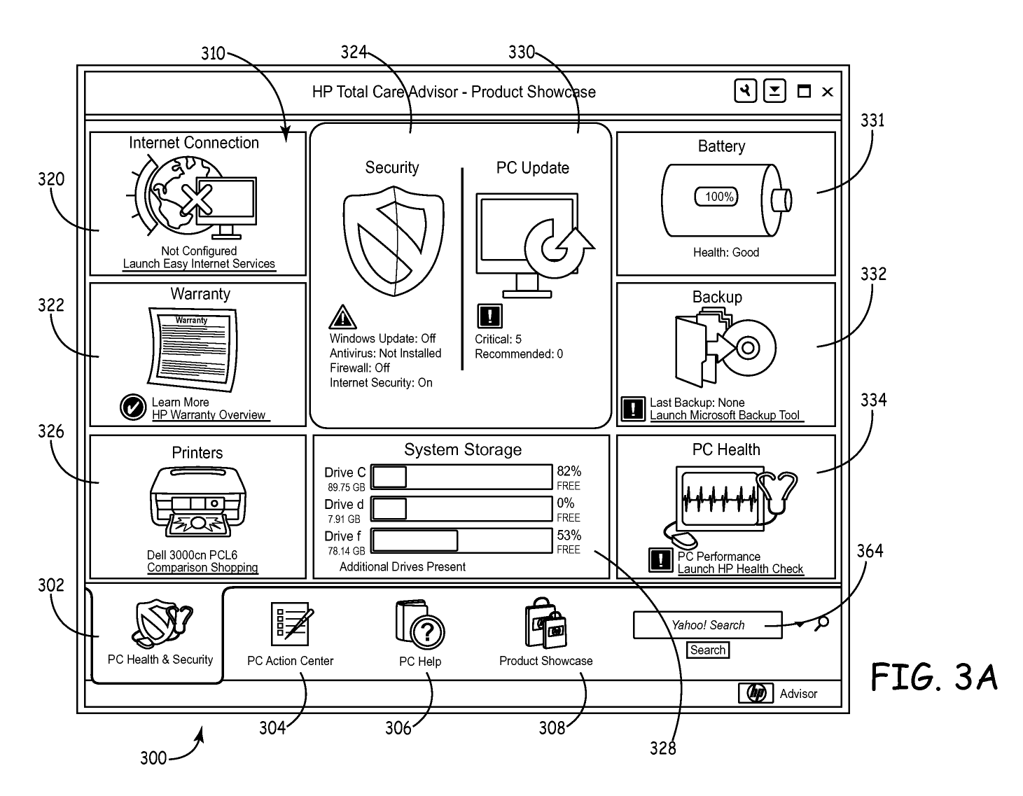

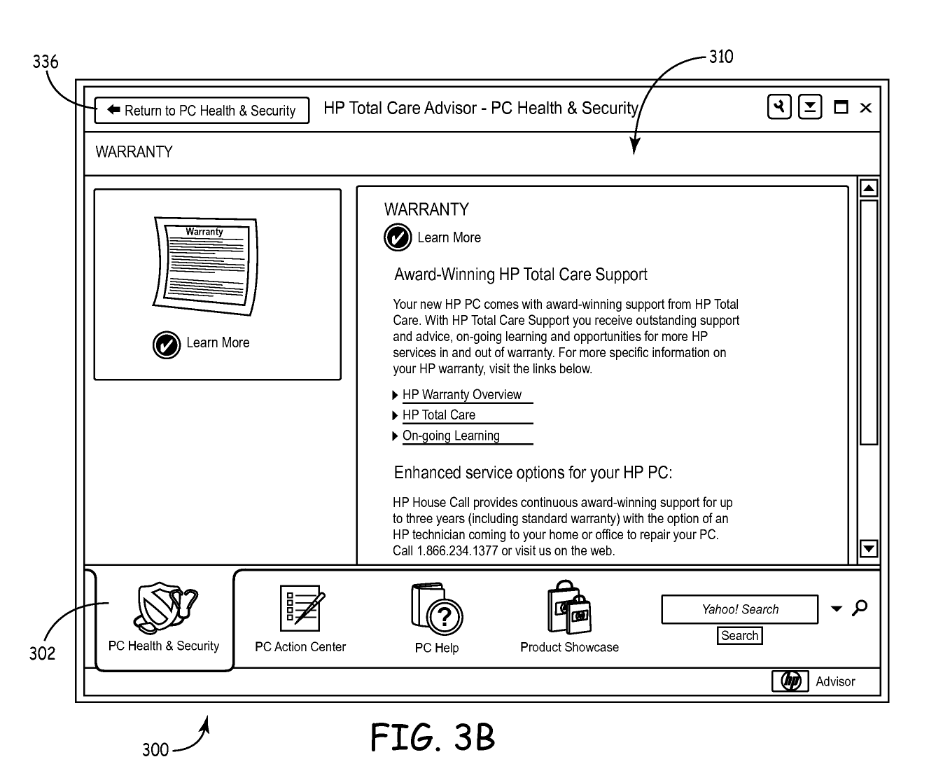

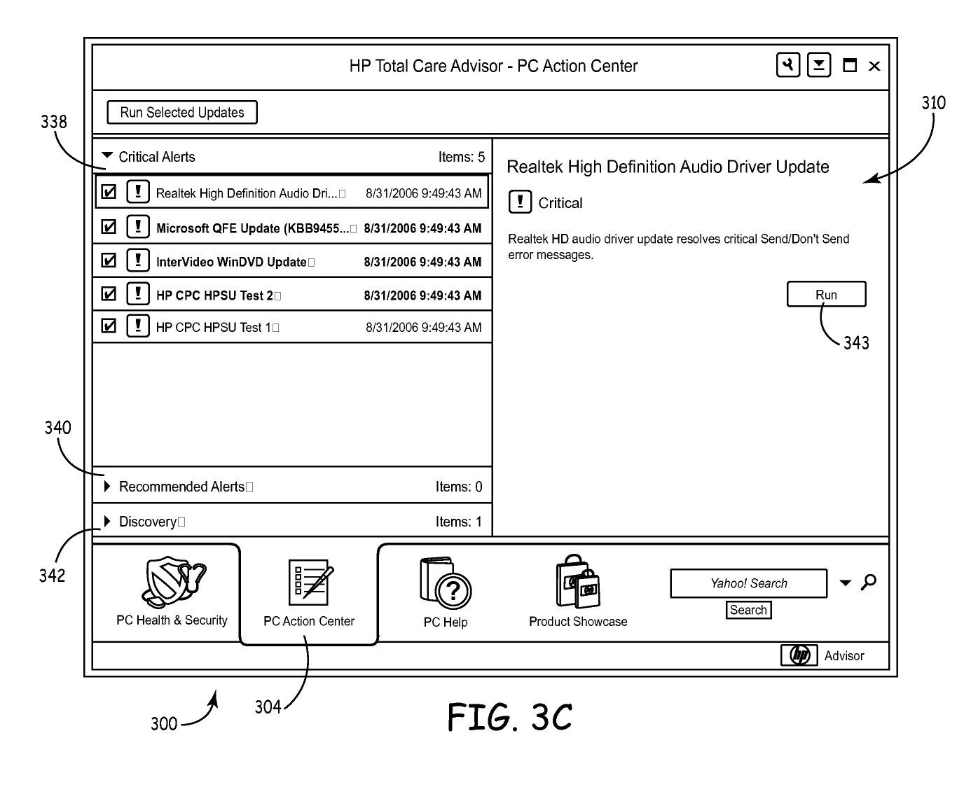

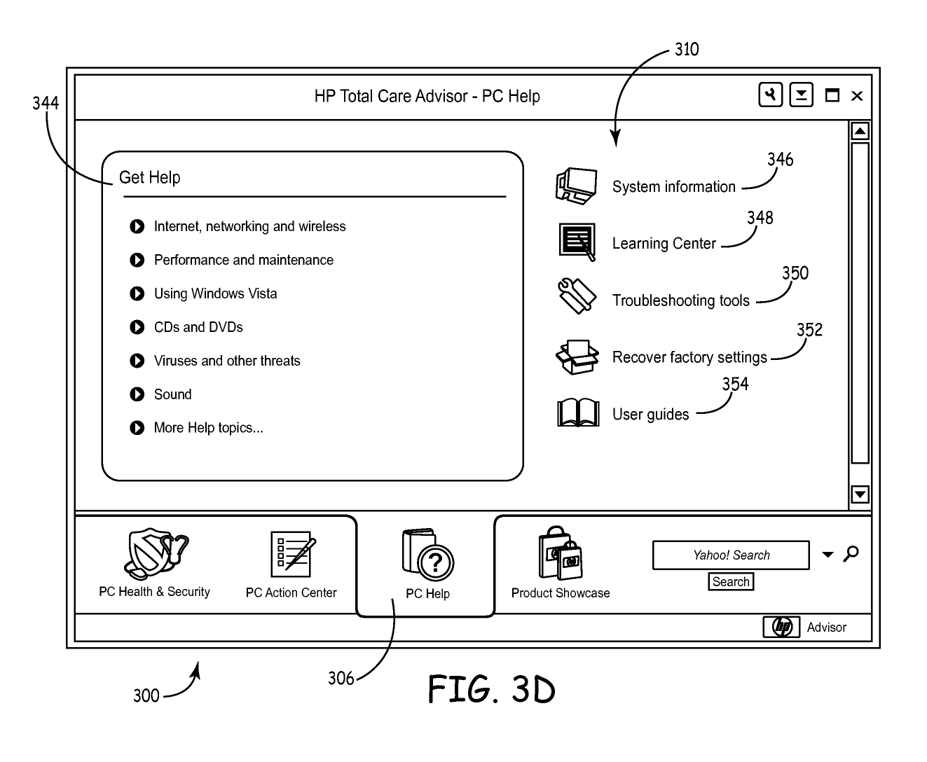

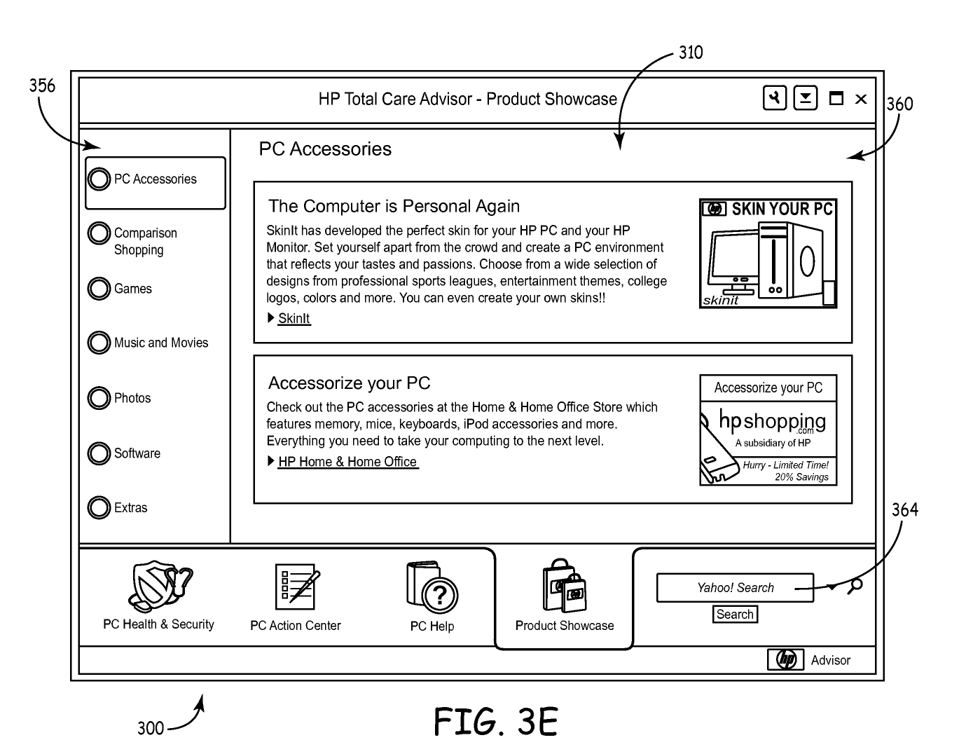

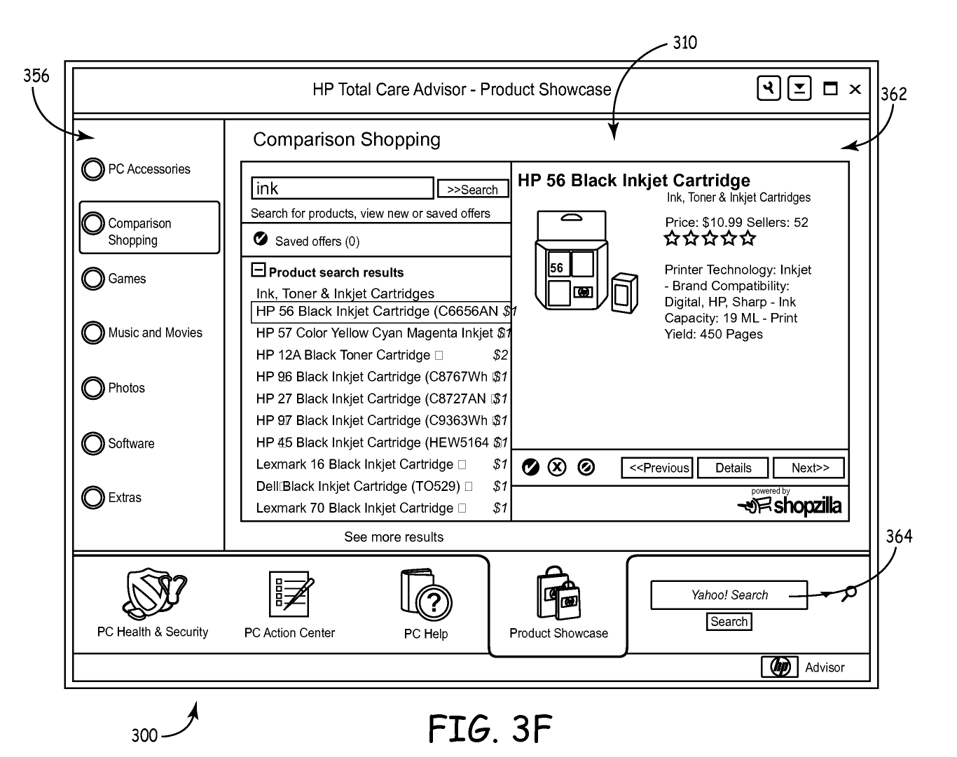

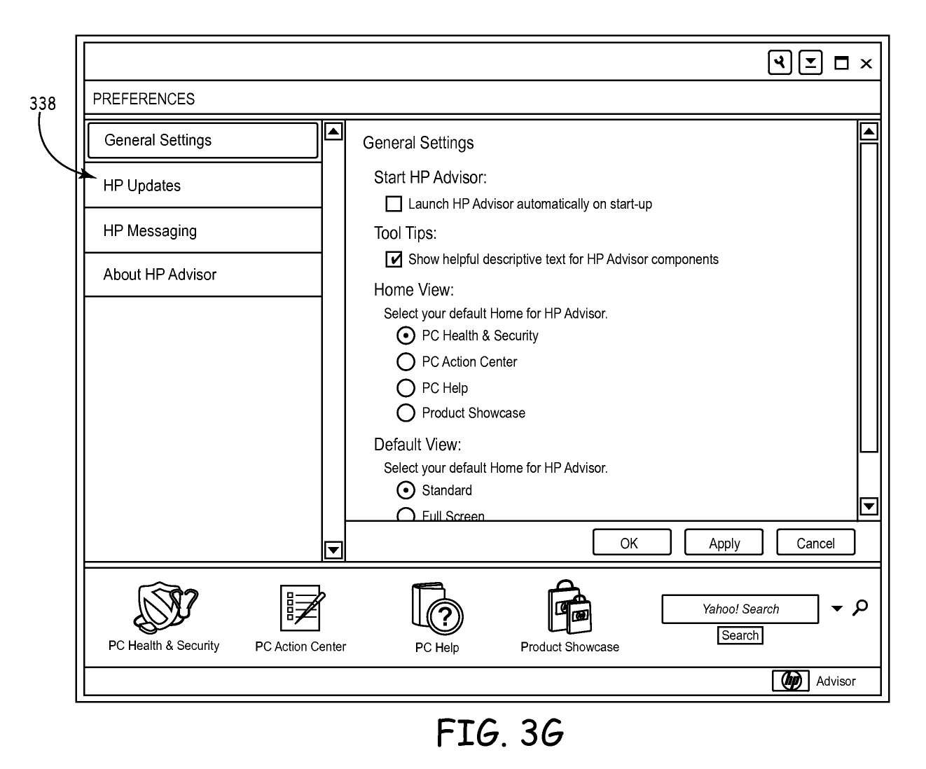

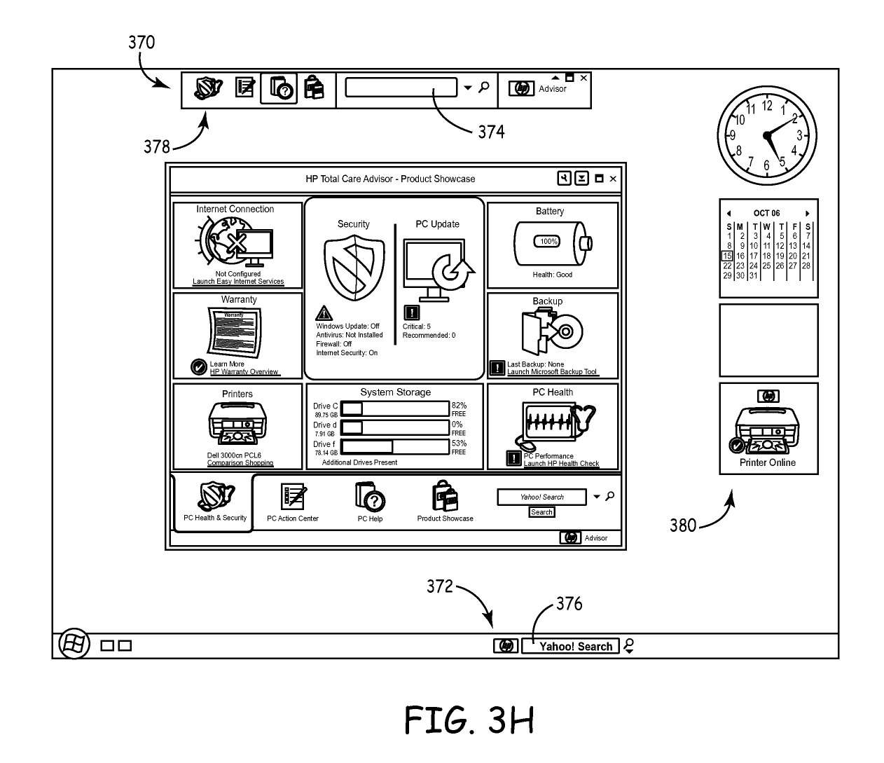

One exemplary embodiment of a user interface 300 suitable for use with the advisor 150 is illustrated in FIGS. 3A-3H. The user interface 300 of the advisor 150 is implemented using a shared user-interface object for displaying system administration information and performing tasks related to the heterogeneous group of resources 202 (typically, system administration tasks). In this embodiment, the shared user-interface object is a window object (though other user-interface objects can be used). In this embodiment, at least three states of the user interface 300 can be presented to a user. One such state is an “open” state in which a full window is displayed and via which content is presented and via which user input is received. One example of the “open” state of the user interface 300 is shown in FIGS. 3A-3F. The user interface 300, while in the open state, is logically grouped into a several “pillars.” In the example of the open state of the user interface 300 shown in FIGS. 3A-3F, the user interface 300 comprises four pillars—a “PC Health and Security” pillar 302, a “PC Action Center” pillar 304, a “PC Help” pillar 306, and a “Product Showcase” pillar 308. The user interface 300 comprises a main pane 310 in which content related to one of the pillars 302-308 is displayed (also referred to here as a “displaying a pillar”). Each of the pillars 302-308 comprises a respective tab 312-318, respectively. A user of the computer 100 can click on (or otherwise actuate, for example, using the keyboard 114) in order to cause the advisor 150 to the display pillar associated with that clicked on tab.

The content that is displayed in the main pane 310 of the user interface 300 comprises one or more content blocks and is also collectively referred to here as a “page”. The advisor 150 makes use of business rules and logic that filters and prioritizes status information and related remedies that are displayed within the content blocks. In the particular exemplary embodiment shown in FIG. 3A, when the PC Health and Security pillar 302 is displayed in the main pane 310, the following content blocks are displayed in the main pane 310—an Internet Connection content block 320, a Warranty content block 322, a Printers content block 324, a Security content block 326, a System Storage content block 328, a PC Update content block 330, a Battery content block 331 (if the computer 100 uses battery power, for example, when the computer 100 comprises a portable computing device such as a notebook computer), a Backup content block 332, and a PC Health content block 334. The PC Health and Security pillar 302 is designed to display information (also referred to here as “content”) related to the “health” of the computer 100 and/or the resources 202 used thereby at a glance by bringing together, into a single display, information related to a diverse group of the most important functions supported by the heterogeneous group of computing resources 202.

The Internet Connection content block 320 contains content that is used to display information and perform tasks related to any internet connection used by the computer (for example, content used to display status information related to the current Internet connection used by the computer 100 and content, that when clicked on by the user, launches software that provides the user with a mechanism to shop and sign-up for connectivity services, including, for example, narrowband, broadband, and wireless service). The Warranty content block 322 contains content that is used to display warranty-related information and perform warranty-related tasks including, for example, content used to display information and perform tasks related to any warranties offered by the vendors of the hardware, software, and peripherals installed in or used with the computer 100. The Printers content block 324 contains content that is used to display printer-related information and perform printer-related tasks including, for example, content used to display information about the status of any printers coupled to the computer 100 and the status of, or offers for, any consumables used by the printers (such as toner or ink cartridges and paper stock).

The Security content block 326 contains content that is used to display security-related information and perform security-related tasks including, for example, content used to display information about whether the update, internet security, and firewall services provided by the operating system 104 or independent security software vendor are installed, turned on, and updated, and whether antivirus software is installed, turned on, and updated. The System Storage content block 328 contains content that is used to display information about the mass storage devices that are used by the computer 100 and perform any related tasks including, for example, content used to display information about the available storage space on the hard disk drives used by the computer. The PC Update content block 330 contains content that is used to display information about any critical updates or alerts related to the heterogeneous group of computing resources 202 that need to be reviewed and/or installed and perform any related tasks (for example, content that, when clicked on, causes the advisor 150 to navigate to a page (such as the page shown in FIG. 3C) that permits the user to install updates). The Battery content block 331 contains content that is used to display battery-related information and perform battery-related tasks. The Backup content block 332 contains content that is used to display information about backups and perform backup-related tasks, including, content used to display information about backups that have been performed for the computer 100 (including, for example, the date the last backup was performed) and content to perform backups for the computer 100. The PC Health content block 334 contains content that is used to display diagnostic and performance information related to the computer 100 and/or the resources 202 used thereby and perform tasks related thereto.

When a pillar is to be displayed in the main pane 310 of the user interface 300, business logic associated with each of that pillar's content blocks assembles the content to be displayed for the respective content block and displays the content for the respective content block in the main pane 310. Also, each of the content blocks has associated therewith one or more action handlers that processes (that is, handles) a user's interaction with the respective content blocks (for example, by clicking on content). For example, in this embodiment, when a user clicks on a portion of the content associated with a particular content block, the action handler associated with the clicked-upon content is executed. In some situations, the action handler causes a new “page” to be displayed in the main pane 310 of the user interface 300. For example, if a user clicks on the “HP Warranty Overview” text displayed in the Warranty content block 322 that is shown in FIG. 3A, an action handler associated with that content causes the content shown in FIG. 3B to be displayed in the main pane 310 of the user interface 300. The user interface 300, in such a situation, also displays “back button” 336 that, if clicked on by a user, causes the user interface 300 to redisplay the page shown in FIG. 3A in the main pane 310. In this example, the action handler displays content that provides additional warranty information (where the displayed content also has one or more action handlers associated therewith that handles user interaction with that content).

In the particular exemplary embodiment shown in FIG. 3C, when the PC Action Center pillar 304 is displayed in the main pane 310, the following content blocks are displayed in the main pane 310—a Critical Alerts content block 338, a Recommend Alerts content block 340, and a Discovery content block 342. The Critical Alerts content block 338 contains content that is used to display those alerts and updates received from or otherwise related to the heterogeneous group of computing resources 202 that the user should review and/or act upon immediately and that are critical for proper and/or secure operation of the computer 100 (for example, certain updates and alerts relating to the operating system 104 or the security-related application software 210). The Recommended Alerts content block 340 is used for displaying those alerts and updates that, while not critical, should be reviewed and acted upon by the user. The Discovery content block 342 is used for displaying other alerts and updates received from or otherwise related to the heterogeneous group of computing resources 202. In the particular embodiment shown in FIG. 3C, when a user clicks on an alert to select it, additional information about the selected alert is displayed. Also, in this embodiment, a user can cause a task associated with the alert to be performed by clicking a “RUN” button 343.

More generally, the PC Action Center pillar 304 is designed to display updates and alerts that originate from the heterogeneous group of computing resources 202. The advisor 150 makes use of business rules and logic that filters and prioritizes the updates and alerts into various categories so that a user of the computer 100 is able to review critical updates and alerts without having to wade through other non-critical alerts and updates. Moreover, one or more action handlers associated with the content displayed in the PC Action Center pillar 304, when executed in response to an associated user interaction, are operable to install (or otherwise run) one or more updates selected by the user or otherwise cause software to be executed for investigating or remediating the condition that caused an alert to be displayed. In this way, a user can review and install updates and otherwise respond to alerts for the heterogeneous group of computing resources 202 via a single interface in which the updates and alerts are filtered and prioritized. In one implementation of such an embodiment, while the advisor 150 is running, the “normal” mechanisms by which the various heterogeneous group of computing resources 202 would otherwise notify the user about such updates and alerts are disabled. By disabling these other “normal” notification mechanisms, the user will not receive such notifications from these disparate mechanisms and, instead, can use the advisor 150 to receive and respond to such notifications in the filtered and prioritized form described above.

In the particular exemplary embodiment shown in FIG. 3D, when the PC Help pillar 306 is displayed in the main pane 310, the following content blocks are displayed in the main pane 310—a Help content block 344, a System Information content block 346, and a Learning Center content block 348, a Troubleshooting Tools content block 350, a Recover Factory Settings content block 352, and a User Guide content block 354. The Help content block 344 is used for accessing help information related to the computer 100 and/or the heterogeneous group of computing resources 202. The System Information content block 346 is used to access system information related to the computer 100 and/or the heterogeneous group of computing resources 202. The Learning Center content block 348 is used to present learning materials related to the heterogeneous group of computing resources 202. The Troubleshooting Tools content block 350 is used for displaying information about, and providing an interface via which a user can execute, various troubleshooting tools related to the computer 100 and/or heterogeneous group of computing resources 202. The Recover Factory Settings content block 352 is used for providing an interface via which a user can restore the factory settings for one or more of the computer 100 and/or the heterogeneous group of computing resources 202. The User Guide content block 354 is used for accessing user guide information related to the computer 100 and/or the heterogeneous group of computing resources 202. In this way, the PC Help pillar 306 provides a single point at which user can access such information and tools for the computer 100 and/or the heterogeneous group of computing resources 202. As a result, the user need not search in various locations for such information and tools.

In the particular exemplary embodiment shown in FIGS. 3E-3F, when the Product Showcase pillar 308 is displayed in the main pane 310, a list of product-category content blocks 356 that are related to particular product categories (such as, for example, PC Accessories, Printing Supplies, Games, Music and Movies, Photos, Software and Extras). The product category content blocks 356 provide information, offers, and recommendations relating to a particular class of products and provide a mechanism for a user to purchase products included in that class of products. When a user clicks on an item included in the listing, content related to that item is displayed in the remained of the main pane 310 of the user interface 300. For example, as shown in FIG. 3E, when the PC Accessories listing content block is clicked, a more detailed PC Accessories content block 360 is displayed. The detailed PC Accessories content block 360 provides information about accessories that can be purchased for the computer 100 (including, for example, “skins” for customizing the computer's case and other accessories such as memory, mice, keyboards, and portable media players). As shown in FIG. 3F, when the Comparison Shopping listing content block is clicked, a more detailed Comparison Shopping content block 362 is displayed, which provides a mechanism to do comparison shopping for products related to the computer 100 and related offers from vendors of such products. The Product Showcase pillar 308 can be used to communicate offers and product information that is tailored to the computer 100 and/or the heterogeneous group of computing resources 202 used therewith. This provides a convenient mechanism for vendors of such products to provide such offers and information to the user of the computer and for a user to easily find such offers and other product information and to comparison shop among such offers.

The open state of the advisor user interface 300 also includes a search bar 364 via which a user can perform a Web search. In one implementation, the results of such a search are displayed in the main pane 310 of the user interface 300. In another implementation, the results of such a search are displayed using an Internet browser installed on the computer 100.

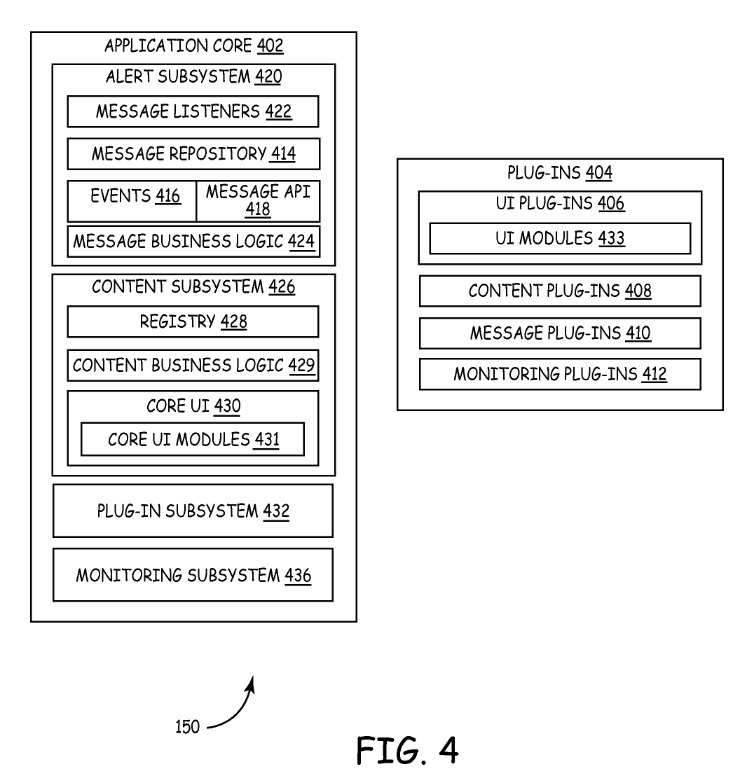

It is to be understood that the advisor 150 can include other functionality (for example, other pillars). In the embodiment of the advisor 150 described below in connection with FIG. 4 below, the advisor 150 is implemented using a modular framework that enables the functionality of the advisor 150 to be reconfigured, expanded, or otherwise enhanced by replacing or adding one or more plug-ins. Examples of such additional functionality include entertainment and news related pillars via which a user can access entertainment and/or new content using the advisor 150 (and thereby avoiding the need to know which particular media player or other client software is needed to access a particular type of content) and a “home networking” pillar via which a user can manage devices that are coupled to a local area network installed in a home (and thereby avoiding the need to learn how to use the device-specific client interfaces to manage such devices).

As shown in FIG. 3G, the user interface 300 provides a page 390 that a user of the computer 100 can use to customize the operation and/or user interface of the advisor 150.

Examples of the other states (also referred to here collectively as the “minimized” states) of the user interface 300 are shown in FIG. 3H. One such minimized state of the user interface 300 of the advisor 150 is a “docked” state in which a “dock gadget” 370 (shown in FIG. 3H) is included in a dock portion of the overall operating-system user interface (for example, in the dock provided by user interface of the MICROSOFT WINDOWS VISTA operating system). In such a dock gadget 370, one or more icons 378 representing the pillars described above are displayed. By clicking such an icon 378, a user can bring up a page associated with the respective pillar.

Another minimized state of the user interface 300 of the advisor 150 is a “deskband” state in which a deskband gadget 372 is included in the deskband portion of the user interface (for example, the deskband provided by the user interface of the MICROSOFT WINDOWS VISTA operating system). In one implementation, the user interface 300 is initially started in a minimized state. When the gadget is clicked on, the open state of the user interface 300 is displayed. Moreover, in the examples shown in FIG. 3H, gadgets 370 and 372 include a search widget 374 and 376 by which a user can initiate a Web search (that is, is displayed in the manner described above). Also, when the user interface 300 is in the open state, the user interface can be changed to the docked or deskband state by clicking on (or otherwise actuating an appropriate user interface control displayed when the user interface 300 is in the open state). In addition, even when the user interface 300 is in a minimized state, the advisor 150 is able to display notifications (also referred to here as “alerts” or “toaster alerts”) by displaying a pop-up window in which an alter message is displayed. This mechanism for displaying alerts even when the user interface 300 of the advisor 150 is in a minimized state is also referred to here as the “toaster user interface”.

Other states of the advisor user interface 300 can be implemented as well. One such example is a “side bar” state in which a side bar gadget 380 is displayed as a part of a side bar pane of the overall operating-system user interface. One or more content blocks (for example, one or more of the content blocks described above) are displayed in the advisor side bar gadget 380. Another example is a “system tray” state in which an icon for the advisor 150 is displayed in the system tray portion of the overall operating-system user interface.

Moreover, in the exemplary embodiment of the advisor user interface 300 shown in FIGS. 3A-3H, all the user interface components are displayed using the user-interface primitives provided by local operating system 104 running on the computer 100. It is to be understood, however, that the user interface of the advisor 150 can be implemented in other ways (for example, implemented as something other than a conventional user interface for a locally executing application). For example, in one such alternative embodiment, the user interface of the advisor 150 is presented by and from a remote Web portal 224 that a user of the computer 100 would otherwise typically visit (for example, because that Web portal 224 is the user's “home page” that is displayed by default by an Internet browser 151). The content that is presented via such a user interface is supplied by the advisor 150 running on the computer 100, and the user input that is received from the user via the user interface is also handled by the advisor 150 running on the computer 100. A suitable Web service or remote procedure call (RPC) is used to support communications between the portal 224 and the advisor 150.

FIG. 4 is a block diagram of one embodiment of the advisor software 150. The embodiment shown in FIG. 4 is described here as being implemented using the computer 100 shown in FIGS. 1 and 2 and the user interface 300 of FIGS. 3A-3H (though it is to be understood that other embodiments can be implemented in other ways).

In the embodiment shown in FIG. 4, the advisor 150 is implemented using a modular framework comprising an application core 402 that implements the baseline functionality of the advisor 150 and one or more plug-ins 404 by which the functionality of the advisor 150 can be reconfigured or extended. In the embodiment shown in FIG. 4, the plug-ins 404 comprise one or more user-interface plug-ins 406, one or more content plug-ins 408, one or more message plug-ins 410, and one or more monitoring plug-ins 412. Each user-interface plug-in 406 implements one or more user-interface modules 433 that are used to display one or more visual user-interface components for presenting content to the user of the computer 100. Each content plug-in 408 implements business logic for obtaining and formatting one or more categories of content (also referred to here as a “content category”) for display in an associated user-interface component and one or more procedures (also referred to here as “action handlers”) for handling or otherwise responding to user input associated with the one or more content categories supported by the content plug-in 408. Each message plug-in 410 implements a wrapper module and/or a remote listener for receiving messages from one or more resources 202 and storing the messages in a message repository 414 (described below). Each monitoring plug-in 412 implements functionality that is used to monitor the interaction of the user of the computer 100 with one or more of the resources 202 and/or the advisor 150, the operation of the advisor 150 and the computer 100, and the use of the various resources 202 by the computer 100. For example, one such monitoring plug-in 412 can be used to monitor the interaction of the user with the user interface 300 of the advisor 150 itself.

The application core 402 also comprise a plug-in subsystem 432 that discovers and gathers information about the plug-ins 404 and load ands unloads the plug-ins 404 as needed.

In the embodiment shown in FIG. 4, the application core 402 comprises an alert subsystem 420. The alert subsystem 420 comprises one or more message listeners 422 that requests and/or receives messages (or other information) from the heterogeneous group of computing resources 202 and stores the received messages in a message repository 414. The message listeners 422 comprise a remote listener 421 that implement an application programming interface (API) (also referred to here as the “external message API”) by which resources 202 are able to communicate messages to the advisor 150. Also, in the particular embodiment shown in FIG. 4, the message listeners 422 also comprise “wrapper” modules 419 that enable a resource 202 to communicate with the advisor 150 using a pre-existing protocol (that is, a protocol other than the external messaging API). The wrapper module 419 serves as an interface between the pre-existing protocol used to communicate with the resource and the rest of the alert subsystem 420. In one implementation of such an embodiment, the wrapper modules 419 are a part of the application core 402. In another implementation, the wrapper modules 419 are implemented as plug-ins.

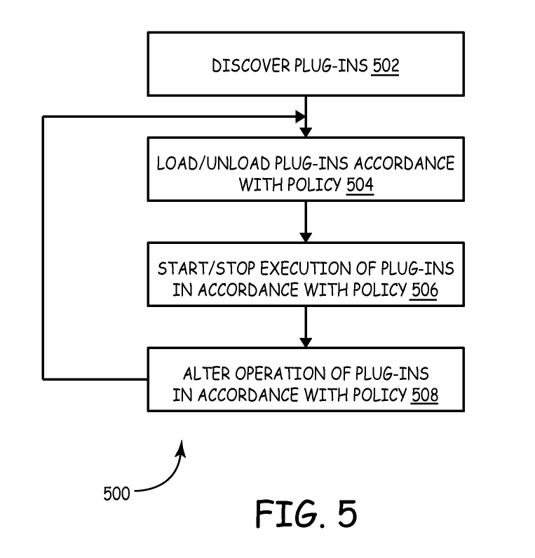

In one implementation of such an embodiment (for example, the one described below in connection with FIG. 5), the advisor 150 is configured to load and unload and start and stop the execution of any plug-ins 410 used to implement message listeners 422 and/or to adjust the frequency with which message listeners 422 check for new messages in accordance with one or more policies. For example, in one implementation where the computer 100 comprises a portable computer, such policy can cause the advisor 150 to unload some message listener plugins 410 entirely and/or reduce the frequency with which some message listeners 422 check for new messages when the portable computer is being powered by a battery. In this way, the amount of power needed to run the advisor 150 can be reduced. Also, in such an implementation, the policy can cause the advisor 150 to load some message listener plug-ins 410 and/or increase the frequency with which some message listeners 422 check for new messages when the portable computer is being powered by the main AC power grid. Also, in some implementations, such a policy is based on whether or not the computer 100 is communicatively coupled to the Internet 122. For example, in one exemplary policy, certain plug-ins 410 are only loaded when the computer 100 is communicatively coupled to the Internet and are unloaded when that is not the case. In some implementations, such a policy is includes a temporal aspect (for example, where certain plug-ins 410 are loaded and executed certain points in time and otherwise are not loaded or executed).

The message listeners 422 filter and prioritizes such received messages and raise any events 416 associated with the reception (or the lack of reception) of such messages (for example, events that indicate that a particular update or alert should be displayed in the advisor 150). The alert subsystem 420 also implements another API 418 (also referred to here as the “internal message API”) by which other parts of the advisor 150 are able to access the messages stored in the message repository 414 and to interact with the resources 202. The message listeners 422 are used to implement that portion of the internal message API 418 that responds to requests to interact with the resources 202. The alert subsystem 420 also implements message business logic 424 that is operable to interact with the message repository 414 and process events 416 for the content blocks and other portions of the application core 402 (for example, to assemble content and to handle user input).

In one implementation of such an embodiment, each message that is received from one of the heterogeneous resources 202 comprises a title for the message and a detailed description that provides the details for the message, both of which can be displayed to a user of the computer 100 via the advisor 150. In such an implementation, each message also comprises an action parameter list that passed to an action hander associated with the message, an action type that identifies a particular type of action handler to call in order to process user input related to the message (for example, execute a particular application executable, access uniform resource locator (URL) using an Internet browser, cause the advisor 150 to navigate to a different pillar of the user interface 300, etc.), a resource identifier that is used to identify the resource that sent the message, a resource message identifier that provides an identifier for the particular message that is used by the resource that sent the message, an identifier that is used by the advisor 150 to identify the message, a severity for the message (for example, critical, recommended, cool) that is used to filter and prioritize the messages, and a description display type that identifies what how to display the detailed description of the message (for example, using the user interface 300 of the advisor 150, using an Internet browser, or some other techniques). In such an implementation, each message also comprises a state field that is used to indicate whether a user has clicked on (or otherwise interacted with) the message via the advisor 150, a batch update field that indicates whether the message the action associated with the message can be run under a “batch” mode or not, an icon path field indicating a path to an icon that is associated with the message, a received on field that indicates the date one which the message received at the advisor 150, an expires on field that indicates when the message “expires” and will no longer be valid or actionable, “elevate severity on” filed that indicates when the severity of the message should be elevated in the event that the message has not been clicked on by a user by that time, an alert field that indicates whether a toaster alert should be displayed for the message even if the advisor 150 is in a minimized state, and an alert repeat fields that indicate if and how often the toaster alert should be repeated in the event that the message has not been clicked on by the user (for example, by specifying when the next toaster alert should be displayed, the frequency at which the toaster alert should be repeated, and/or a specific number of times the toaster alert should be repeated). In other embodiments and implementations, other information is received from the resources 202 and/or is formatted and processed in other ways.

In one implementation of such an embodiment, the messages (and related information) are archived and stored, even after the messages have been reviewed and processed by the user. Such archived messages are used, for example, by the monitoring subsystem 436 described below and for investigating problems that may result from taking an action related to such a message (for example, installing an update associated with a message).

The application core 402 also comprises a content subsystem 426 that manages content and the user interface 300 for the advisor 150. The content subsystem 426 comprises a registry 428 for registering content with the one or more application handlers that handle interactions with that content and for binding user-interface modules with the content categories that are displayed using that user-interface module. The content subsystem 426 also comprises content business logic 429 that assembles content for display within an appropriate content category (and content block included therein) and causes any user interaction with such content to be processed by the action handler that is registered to handle such interaction. The content subsystem 426 also comprises core user-interface functionality 430 that implements the baseline user-interface framework for the advisor 150 that is populated with content provided by the user-interface plug-ins 406, as well as the minimized states of the user interface 300. In the particular embodiment shown in FIG. 4, this baseline user-interface framework includes several user-interface modules 433 for displaying content when the user interface 300 is in an open state and one or more toaster modules 435 for displaying alerts or other notifications while the user interface 300 is in a minimized state.

In one implementation of such an embodiment, a “reference-by-name” scheme in which the name-type of the action associated with the content displayed in the user interface is used by the core user-interface functionality 430 to reference that content in connection with the processing performed thereby (for example, displaying the associated content and identifying the action handler for any user input received in connection with that content). By using such a reference-by-name scheme, the user interface 300 of the advisor 150 can more easily be altered or extended since the core UI functionality 430 need not be modified to alter or extend the user interface 300.

The application core 402 also comprises a monitoring subsystem 436 that manages any monitoring that is performed by the advisor 150. More specifically, the monitoring subsystem 436 controls the operation of the monitoring plug-ins 412. As noted above, the monitoring plug-ins 412 are used to monitor the interaction of the user of the computer 100 with one or more of the resources 202 and/or the advisor 150, the operation of the advisor 150 and the computer 100, and the use of the various resources 202 by the computer 100. The monitoring subsystem 436 (and appropriate monitoring plug-ins 412) also implements functionality to store the usage and monitoring information locally at the computer 100 (for example, on a local hard disk) and/or to communicate at least some of the usage or monitoring information to or otherwise interact with the usage information warehouses 232 and/or the local behavior detection and recommendation software 220. In one implementation of such an embodiment, at least some of the monitoring information is used by such resources 202 to generate one or more messages (or other information) that are communicated back to the advisor 150 (for example, a message about a software update, a message about a product offering, and a message about a content update) for processing thereby as described here.

FIG. 5 is a flow chart of one embodiment of a method 500 of managing plug-ins suitable for use with the advisor 150 of FIG. 4. The particular embodiment of method 500 shown in FIG. 5 is described here as being implemented using the computer 100 of FIGS. 1-2 and the embodiment of the advisor 150 of FIGS. 3A-3H and 4 (though it is to be understood that other embodiments can be implemented in other ways). In such an embodiment, method 500 is performed by the plug-in subsystem 432 shown in FIG. 4.

When the advisor 150 is executed, the plug-in subsystem 432 discovers all plug-ins 404 that have been installed for use with the advisor 150 (block 502). In one implementation, the advisor 150 and the operating system 104 is configured so that the application core 402 of the advisor 150 is executed the very first time a purchaser (user) of the computer 100 boots the computer 100 so that the user can be informed of the existence of the advisor 150 and the functionality provided thereby and so that the user can be prompted to perform some initial configuration tasks. Also, the operating system 104 is typically configured to execute the application core 402 of the advisor 150 each time the computer 100 is booted.

In one implementation of such an embodiment, the plug-in subsystem 432 maintains information about the plug-ins 404 that have been installed for use with the advisor 150 (for example, in an configuration file or a registry maintained by the operating system 104), including where the plug-ins 404 are stored (for example, in a particular directory maintained on a local hard disk of the computer 100).

During the plug-in-discovery process, the plug-in subsystem 432 confirms that the installed plug-ins 404 are stored in an appropriate location and collects (and registers with operating system 104) metadata about the plug-ins 404 that is needed for other parts of the advisor 150 to interact with each of the plug-ins 404. In general, each plug-in 404, in accordance with one or more policies, is loaded and unloaded, its execution started and stopped, and its operation otherwise altered or adjusted (blocks 504, 506, and 508). In general, such policies can be configured so that, for example, the advisor 150 does not use an excessive amount of any particular resource (such as battery power, memory, processor time, or network bandwidth) and/or to reduce the impact that the execution of the advisor 150 otherwise has on the operation of the computer 100.

For example, in one implementation of such embodiment, a policy identifies which plug-ins 404 are to be loaded and executed throughout the time the advisor 150 (also referred to here as “background” plug-ins) is executing and the computer 100 is not in a hibernation mode. In such an exemplary implementation, at least some of the message plug-ins 410 are background plug-ins that are loaded, initialized, and executed after the discovery process is complete. In such an implementation, the policy identifies which plug-ins can be loaded and unloaded and their execution started and stopped on demand as they are needed (also referred to here as “on-demand” plug-ins). In such an exemplary implementation, at least some of the message plug-ins 410, the user-interface plug-ins 406, the content plug-ins 408, and the monitoring plug-ins 412 are on-demand plug-ins. When there is a need for the functionality provided by an on-demand plug-in, the plug-in subsystem 432 loads, initializes, and executes that needed on-demand plug-in. Thereafter, when that on-demand plug-in is no longer needed at that time, the plug-in subsystem 432 stops the execution of and unloads that on-demand plug-in in accordance with one or more policies. For example, in such an exemplary implementation, one such policy relates to user-interface plug-ins 406. When the user interface 300 needs to use a particular user-interface module that is implemented by that user-interface plug-in 406, the policy indicates that the plug-in subsystem 432 should load, initialize, and execute that user-interface plug-in 406 in order to use that user-interface component. When the content associated with that user-interface plug-in 406 is no longer displayed and the user 100 has navigated to a different pillar or minimized the user interface 300, the policy indicates that the plug-in subsystem 432 should stop the execution of and unload that user-interface plug-in 406. In other implementations, the execution of such a plug-in is stopped but the plug-in is not unloaded.

In another example, a policy causes the advisor 150 to stop the execution of and/or unload one or more plug-ins when the computer 100 enters a hibernation mode and to start (or restart) the execution of and/or load (or reload) one or more plug-ins when the computer 100 exits the hibernation mode and enters a normal operational mode. In such an example, different actions can be taken for different hibernation modes. Moreover, as noted above, such policies can load and unload, start and stop the execution of, and/or otherwise adjust the operation of plug-ins based on whether the computer 100 is being powered by a battery and/or whether the computer 100 is communicatively coupled to the Internet. Also, as noted above, such policies can include a temporal aspect.

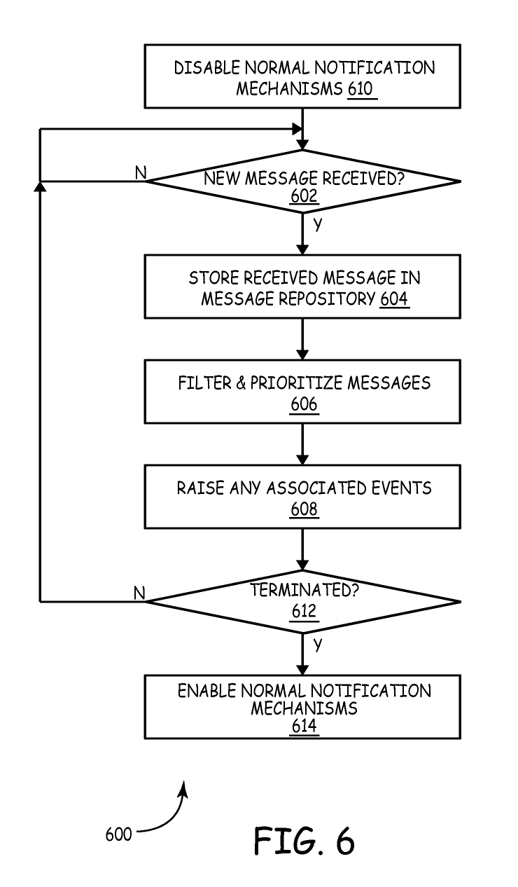

FIG. 6 is a flow chart of one embodiment of a method 600 of processing messages received from the heterogeneous group of computing resources 202 at the advisor 150. The particular embodiment of method 600 shown in FIG. 6 is described here as being implemented using the computer 100 of FIGS. 1-2 and the embodiment of the advisor 150 of FIGS. 3A-3H and 4-5 (though it is to be understood that other embodiments can be implemented in other ways). In such an embodiment, method 600 is performed by each of the message listeners 422 shown in FIG. 4.

When a message is received by a message listener 422 (checked in block 602), the received message is stored in the message repository 414 (block 604) and the message listener 422 filters and prioritizes the received messages (block 606) and raises any relevant events 416 that are associated with the received message (block 608). In one implementation, some of the message listeners 422 poll or otherwise request or check for new messages or information from one or more of the heterogeneous group of computing resources 202 (for example, from network resources 130 that are accessed over the Internet). At an appropriate time, the message listener 422 polls the resource 202 serviced by that message listener 422 (or otherwise check for new messages or information from that resource 202). If there is a new message or information, the new message is received and stored in the message repository 414 as described above in connection with blocks 602-608.

In the particular embodiment shown in FIG. 6, for any messages from a particular resource that are being handled by a message handler as described above in connection with blocks 602-608, the “normal” mechanisms by which a computing resource 202 would otherwise notify the user about such messages (for example, by displaying a system tray notification message) are disabled (block 610). By disabling these other “normal” notification mechanisms for all of the computer resources 202 that are to be handled by the advisor 150, the user will not receive such notifications from the disparate “normal” notification mechanisms and, instead, can use the advisor 150 to receive and respond to such notifications in the filtered and prioritized form described above. As shown in FIG. 6, when the advisor 150 is terminated or the message handler for the particular resource is no longer handling messages from that resource (checked in block 612), the disabled normal mechanisms are re-enabled (block 614). In this way, the normal mechanisms are used to provide notifications related to any such messages when the advisor 150 is not running.

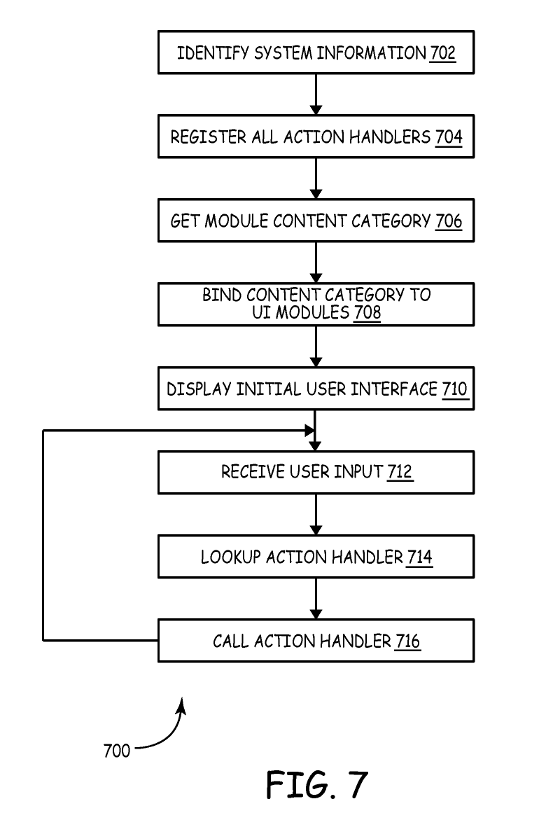

FIG. 7 is a flow chart of one embodiment of a method 700 of displaying content in a user interface of the advisor 150. The particular embodiment of method 700 shown in FIG. 7 is described here as being implemented using the computer 100 of FIGS. 1-2 and the embodiment of the advisor 150 of FIGS. 3A-3H and 4-7 (though it is to be understood that other embodiments can be implemented in other ways). In such an embodiment, method 700 is performed by the content subsystem 426 shown in FIG. 4.

When the advisor 150 is executed, the content subsystem 426 identifies system information (block 702). Such system information includes, for example, locale information (including, for example, information about the time zone in which the computer 100 is used and the preferred natural language of users of the system), platform information (including, for example, information identifying the operating system, CPU, and other resources used by the computer 100), and brand information (including, for example, information about the brand of the computer 100). The system information is used to populate the user interface 300 and customize the displayed content (for example, by using the identified time zone and preferred natural language for displaying time and textual information, causing the alert subsystem 420 to listen for messages that are related to the software, hardware, and other resources used in or with the computer 100 and downloading and installing updates related thereto, and providing warranty information, advertisements, and product offers associated with the particular brand of software, hardware, and other resources used in or with the computer 100).

The content subsystem 426 registers all action handlers (block 704). In one implementation of such an embodiment, the plug-in subsystem 432, as a part of the discovery process (described above in connection with block 502 of FIG. 5), interacts with the content subsystem 426 in order to register the action handlers that are implemented by the plug-ins 404. Also, in such an implementation, the content subsystem 426 registers all action handlers that are implemented by the application core 402.

The content subsystem 426 identifies all the content categories that are used by the various user-interface modules of the advisor 150 (block 706). Each user-interface module is used to display a logical portion or state of the user interface 300 (for example, a page of content or a portion thereof). The functionality that implements the various user-interface modules includes the default user-interface modules 431 included in the core user-interface functionality 430 and various user-interface modules 433 implemented by the user-interface plug-ins 406. Each content category identifies the set of content that is displayed by a particular UI module when it is presented in the user interface 300. A set of content is also referred to here as a “content block”. Thus, in such an embodiment, each content category comprises one or more content blocks, each of which identifies a title for the content block, the content to be displayed (which is retrieved or generated when needed by associated content business logic 429 and/or a content plug-in 408) and an “action bundle” used to identify how to handle user input that is associated with the content block. Each action bundle identifies a particular type of action to be performed in order to handle the user input, where the action type is used to select an action handler that is executed in order to handle the user input. Each action bundle also identifies any parameters that are to be supplied to the selected action handler and “display text” that is displayed in the user interface 300 when such user input is received and the action handler is executed.

The content subsystem 426 binds each identified content category to each user-interface module that uses that content category (block 708). This binding is done so that the core UI functionality 430 can cause appropriate content to be displayed by each of the user-interface modules 431 and 433 of the advisor 150 and cause the appropriate action handlers to be executed to handle user input received via each of the user-interface modules 431 and 433.

The content subsystem 426 also displays the default state of the user interface 300 for the advisor 150 (block 710). In such an embodiment, the advisor 150 is configured so that when the advisor 150 is executed and the processing of blocks 702-708 has been completed, the content subsystem 426 displays the user interface 300 in its default state 300. For example, in one implementation, the advisor 150 is configured so that the user interface 300 of the advisor 150 is displayed in the open state when the computer 100 is turned on for the very first time by a purchaser of the computer 100. Thereafter, the default or initial state of the user interface 300 can be changed (for example, a minimized state). When a user of the computer 100 interacts with the user interface 300 by providing user input to the advisor 150 (block 712), the content subsystem 426 looks up and calls an action handler to handle that user input (blocks 714-716). More specifically, when a user clicks on a particular item of content displayed in the user interface 300 (or provides an equivalent user input, for example, via a keyboard), the content subsystem 426 determines the action type that is associated with the content block of which the clicked-on content is a member. The action type is used to identify the action handler that has been registered for that action type. The content subsystem 426 then causes that action handler to be executed (that is, called) using any parameters that are associated with that content block (for example, text that has been entered into a text box or selections provided by one or more selection UI controls or widgets). The action handler, in the course of handling the user input, may refresh the user interface 300 and/or cause the user interface 300 to display a new page or other logical unit. In this way, “navigation” between various pages or portions thereof of the user interface 300 can be implemented.

The particular embodiment of method 700 shown in FIG. 7 uses a “reference-by-name” scheme in which the name of the content as displayed in the user interface 300 is used by the core user-interface functionality 430 to reference that content. By using such a reference-by-name scheme, the user interface 300 of the advisor 150 can more easily be altered or extended since the core UI functionality 430 need not be modified to alter or extend the user interface 300. The core UI functionality 430 displays the content blocks specified for the particular content category that has been bound to a particular user-interface module and, when user input for a particular content block is received, calls the action handler associated with that content block. That is, how content is displayed and user input is processed are not hard-coded in the core UI functionality 430, which would necessitate that the core UI functionality 430 itself be changed in order to alter or expand the user interface 300 of the advisor 150.

One example of a content block that is used with this embodiment of the advisor 150 is a content block that displays content that is indicative of a task to be performed (for example, a system administration task). In this example, the action handler that is associated with that content block executes software that is able to perform that task (for example, by executing an application that performs that task with no additional input from the user or by executing an Internet browser or other application by which the user is able to cause the task to be performed by supplying appropriate input). When a user clicks on that content, that action handler is called.

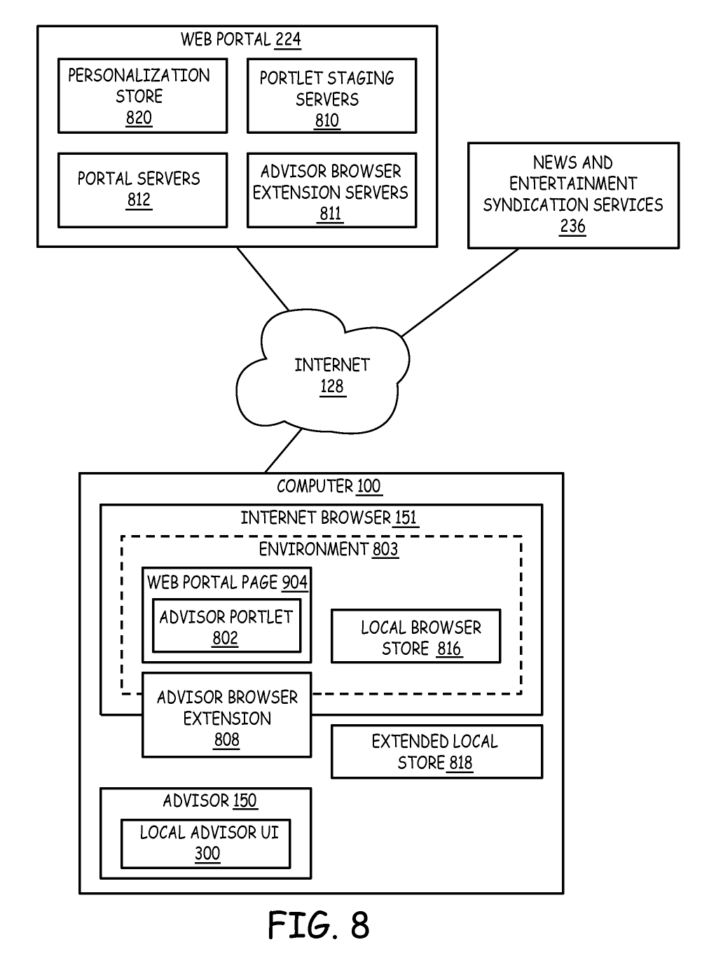

FIG. 8 is a block diagram of one embodiment of an alternative user interface for the advisor 150. The embodiment shown in FIG. 8 is described here as being implemented using the computer 100 shown in FIGS. 1 and 2 (though it is to be understood that other embodiments can be implemented in other ways).

In such an embodiment, the user interface of the advisor 150 is presented by and from a remote Web portal 224 (shown in FIG. 2) that a user of the computer 100 would otherwise typically visit (for example, because that Web portal 224 is the source of the user's “home page” that is displayed by default by an Internet browser 151). At least a portion of the content that is presented via such a user interface is supplied by the advisor 150 running on the computer 100, and the user input that is received from the user via the user interface is also handled by the advisor 150 running on the computer 100.

The functionality of the user interface, in such an embodiment, is implemented as a “portlet” 802 (also referred to here as the “advisor portlet” 802) that is included in a Web portal page 804. Generally, a portlet is a pluggable user interface component that is managed and displayed as a part of a portal page. Each such portlet comprises markup code, which is assembled by an Internet browser 151 (or other client software) into the portal page. Typically, the Internet browser 151 displays such a portal page as a collection of non-overlapping portlet windows, where each portlet window displays content associated with the associated portlet. The advisor portlet 802 is implemented using suitable portlet technology (for example, hypertext markup language (HTML), extensible markup language (XML), javascript, Web Services for Remote Portlets (WSRP) and/or Iframes). The portlet 802 (and the code associated therewith) is executed within a special-purpose environment or sandbox 803 associated with the Internet browser 151. This environment 803 implements a firewall that prevents processes executing with the environment 803 from accessing other resources provided by the computer 100 (for example, files, memory, and network resources that are managed by the computer's operating system 106). Typically, portlets are used to present a user interface or content for remotely executing applications or for an applet that is downloaded to a computer for execution within the special-purpose environment or sandbox associated with the Internet browser. In contrast to such typical uses of portlet technology, in the embodiment described here in connection with FIG. 8, portlet technology is used to present a user interface for a “regular” local application that is executing on the computer 100 outside of a special-purpose environment or sandbox associated with the Internet browser 151.

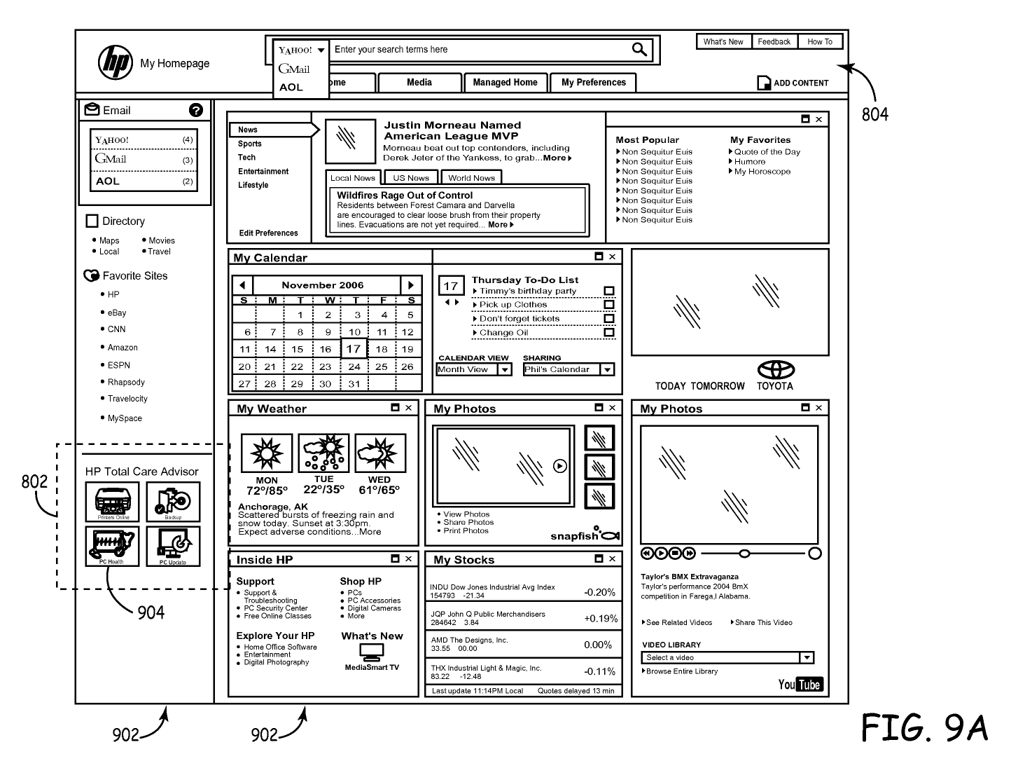

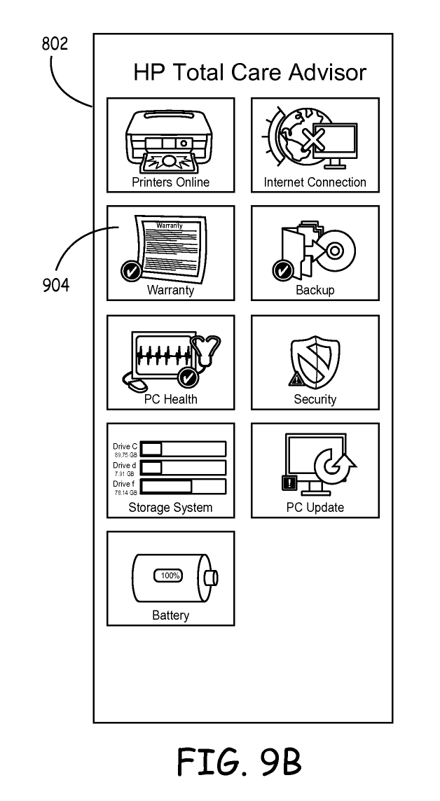

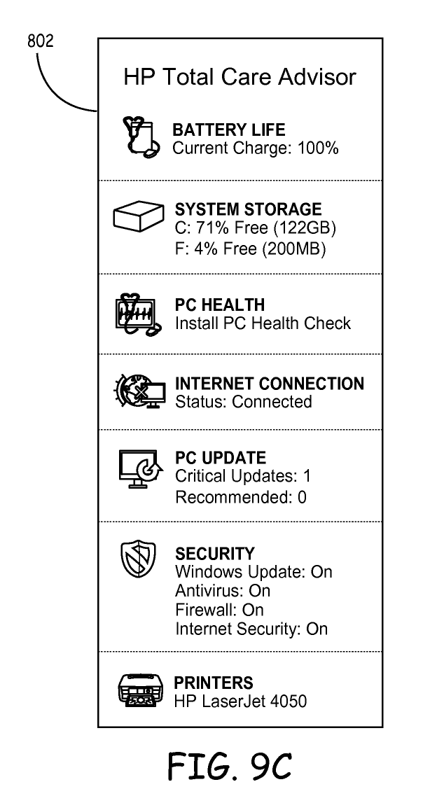

One example of such a user interface is shown in FIGS. 9A-9C. As shown in FIG. 9A, the advisor portlet 802 is displayed as a part of a Web portal page 804. In the particular example shown in FIG. 9A, the Web portal page 804 comprises multiple columns 902, and the advisor portlet 802 is displayed in one of the columns 902. It is to be understood, however, that Web portal pages can be implemented in other ways (for example, using single column pages). In this example, when the main Web portal page 804 is displayed, a “short form” version of the advisor portlet 802 is displayed. This short-form version of the advisor portlet 802 comprises a limited number of icons 904 that are used to display advisor-related information. In the particular embodiment shown in FIG. 9A, the advisor portlet 802 includes four icons 904 from the PC Health and Safety pillar 302 described above in connection with FIG. 3A. The icons 904 are dynamically updated with information from the advisor 150. When a user clicks on such an icon 904, more detailed content related to the subject matter of that icon can be displayed in the Internet browser 151 (for example, within the window of the Web portal page 804 associated with the advisor portlet 802 or within an entirely new web page or in the open state of the local user interface 300 of the advisor 150 described above) and/or one or more tasks can be performed.

Typically, the Web portal 224 provides a mechanism by which a user of the Web portal 224 is able to modify the layout and content of the Web portal page 804 (also referred to here as “customization” or “personalization” of the Web portal page 804). This personalization functionality can be extended to provide a user with a mechanism to personalize the layout and content of the advisor portlet 802. For example, as shown in FIG. 9B, the exemplary advisor portlet 802 shown in FIG. 9A can be personalized to display additional icons 904.

It is to be understood that the advisor portlet 802 can be displayed in other ways. For example, as shown in FIG. 9C, a “long form” version of the advisor portlet 802 can be displayed as a part of the Web portal page 804. This long form version of the advisor portlet 802 comprises more information than the short form version shown in FIGS. 9A-9B. In another example, the advisor portlet 802 displays some advisor-related content using “overlays” displayed over a portion of the Web portal page 804. Such an approach can be used, for example, to display critical alerts.

As shown in FIG. 8, an advisor browser extension 808 is used to dynamically interact with the advisor 150 executing locally on the computer 100. The browser extension 808 is used to tunnel through the firewall implemented by the environment 803 associated with the Internet browser 151. The browser 808 is used to tunnel through the firewall in order to access resources that are outside of the environment 803 such as the advisor 150. For example, the advisor portlet 802 uses the advisor browser extension 808 to detect whether an instance of the advisor 150 is executing on the computer 100, to get status and alerts from the advisor 150, to obtain other content from the advisor 150 (for example, images), populate the advisor portlet 802 with content, and to provide user input to the advisor 150 for processing thereby. In one implementation, the advisor portlet 802 and advisor browser extension 808 are implemented using, for example, Javascript, dynamic HTML (DHTML), IFrames and Asynchronous JavaScript and XML (AJAX) scripting. Also, the advisor portlet 802 uses the advisor browser extension 808 directly interact with the advisor 150 (that is, without interacting with the portal server 812 (described below)) in order to provide good response times. For example, the advisor portlet 802 can use the advisor browser extension 808 to cause the advisor 150 invoke one or more action handlers to process user input that relates to the advisor portlet 802 and that was received by the Internet browser 151 (for example, to cause different content to be displayed by the advisor portlet 802, to cause the advisor 150 to display the user interface 300 in the open state 302, and/or to cause one or more tasks to be performed).

The Web portal page 804 and the advisor portlet 802 are supplied by one or more remote servers that are communicatively coupled to the computer 100. In the embodiment shown in FIG. 8, the code that implements the advisor portlet 802 is stored on one or more portlet staging servers 810 that are communicatively coupled to one or more portal servers 812. Also, in such an embodiment, the advisor browser extension 808 is stored on one or more advisor browser extension servers 811 that are communicatively coupled to the one or more portal servers 812. When a user of the computer 100 uses an Internet browser 151 to visit the Web portal 224, the Internet browser 151 communicates with at least one of the portal servers 812 (for example, via an appropriate load-balancing mechanism). The portal server 812 provides to the Internet browser 151 any markup or other code, and content associated with the portlet 802 that are needed by the Internet browser 151 to display the Web portal page 804. The portal server 812 retrieves any such needed markup or other code or content from one or more sources that are communicatively thereto (for example, from a portlet staging server 810, local storage maintained by the portal server 812, and/or one or more other servers that are coupled to the portal server 812). It is to be understood that the portal sever 812, the portlet staging servers 810, the advisor browser extension servers 811 may all be located at the same physical location or data center or may be located in different locations or data centers. In the event that an appropriate version of the advisor browser extension 808 is not installed on the computer 100, an appropriate version of the advisor browser extension 808 is supplied from the advisor browser extension server 811 to the computer 100.

One issue with using a Web portal page 804 as a user interface of the advisor 150 is that a user may access the Web portal 224 from different computers, some of which will not have the advisor 150 installed or enabled for various reasons. Moreover, the Web portal page 804 typically includes other portlets in addition to the advisor portlet 802. Thus, it may be desirable to provide mechanisms to quickly suppress the display of the advisor portlet 802 as a part of the Web portal page 804 when the Web portal page 804 is accessed from a computer 100 that does not use the advisor 150. By suppressing the display of the advisor portlet 802 in this manner, unnecessary advisor-related processing (and the need to wait for certain functionality to “time out”) need not be performed, thereby avoiding negatively impacting response times for the Web portal page 804. The presence and capability (for example, the version) of any advisor 150 running locally on the computer 100 is detected upon the initial load of the Web portal page 804 and is remembered at the Internet browser 151 in a local browser store 816 for the remainder of that session. The local browser store 816 is used to determine the presence and capability of the advisor 150 for subsequent Web portal page 804 loads, which avoids having to repeat the advisor-detection processing described below. In one implementation, the local browser store 816 is implemented using cookies.

An extended local store 818 is maintained at the computer 100 by the advisor browser extension 808 to cache user-interface artifacts used to implement the user interface of the advisor 150. Examples of such user-interface artifacts include images and internationalized text. The extended local store 818 is also used to store user preferences for the advisor portlet 802. A personalization store 820 is also maintained by the portal server 812. The personalization store 820 is used to store information related to personalization of the Web portal page 804, which includes personalization information that relates to the advisor portlet 802. Examples of personalization information that relates to the advisor portlet 802 includes information about on which Web portal page 804 the advisor portlet 802 should be displayed, where the advisor portlet 802 should be displayed on the Web portal page 804, the size of the window for the advisor portlet 802, and any style sheets used for the advisor portlet 802.

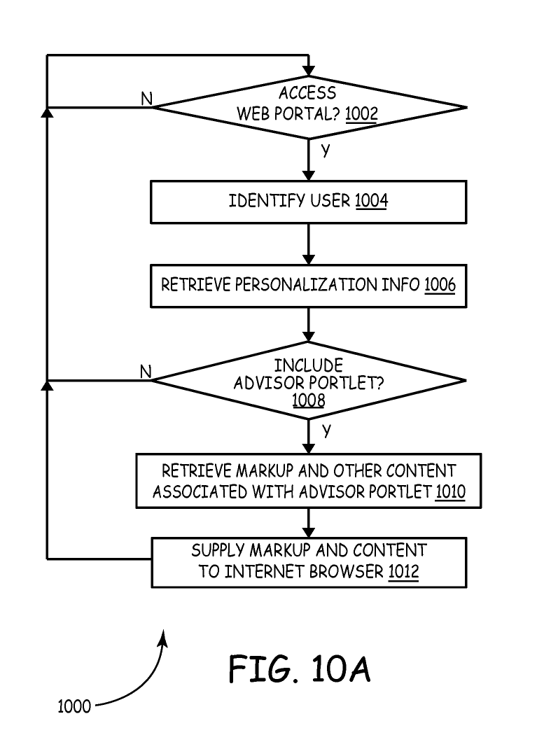

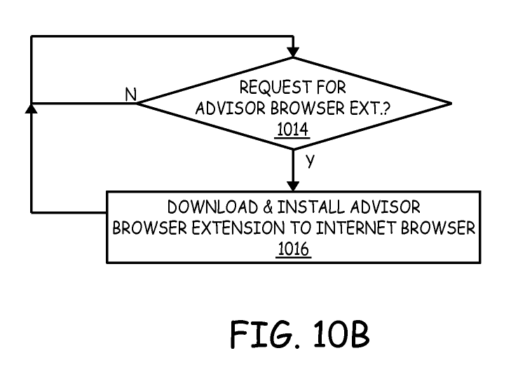

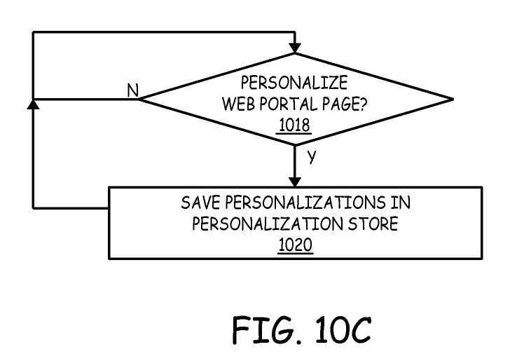

FIGS. 10A-10C are flow charts of one embodiment of a method 1000 of providing a user interface using an advisor portlet 802. The particular embodiment of method 1000 shown in FIG. 10 is described here as being implemented using the computer 100 of FIGS. 1-2 and the embodiment of the advisor 150 of FIGS. 3A-3H and 4-8 and 9A-9C (though it is to be understood that other embodiments can be implemented in other ways). In this embodiment, the processing of method 1000 is performed by one or more processes executed by one or more portal servers 812, the portlet staging servers 810, and/or the advisor browser extension servers 811.

When a user uses an Internet browser 151 to access the Web portal 224 by accessing an URL associated with the Web portal 224 (block 1002 shown FIG. 10A), the portal server 812 identifies the user of the Internet browser 151 (block 1004). The user is identified using, for example, an authentication process in which the user is required to supply a user name and a password. The portal server 812 itself (or an authentication server that is communicatively coupled thereto) determines if the supplied user name and password are correct. If not, no further advisor-portlet-related processing is performed and, in some implementations, a static portlet message is displayed and/or the advisor portlet 802 is not displayed. If the supplied user name and password are correct, the portal server 812 retrieves any personalization information associated with that user name stored in the personalization store 820 (block 1006). If the retrieved personalization information indicates that the Web portal page 804 for that user name is configured to include the advisor portlet 802 (block 1008), the markup code and other content associated with the advisor portlet 802 is retrieved from the portlet staging server 810 (block 1010) and supplied to the Internet browser 151 used by the user along with the rest of the Web portal page 804 (block 1012).

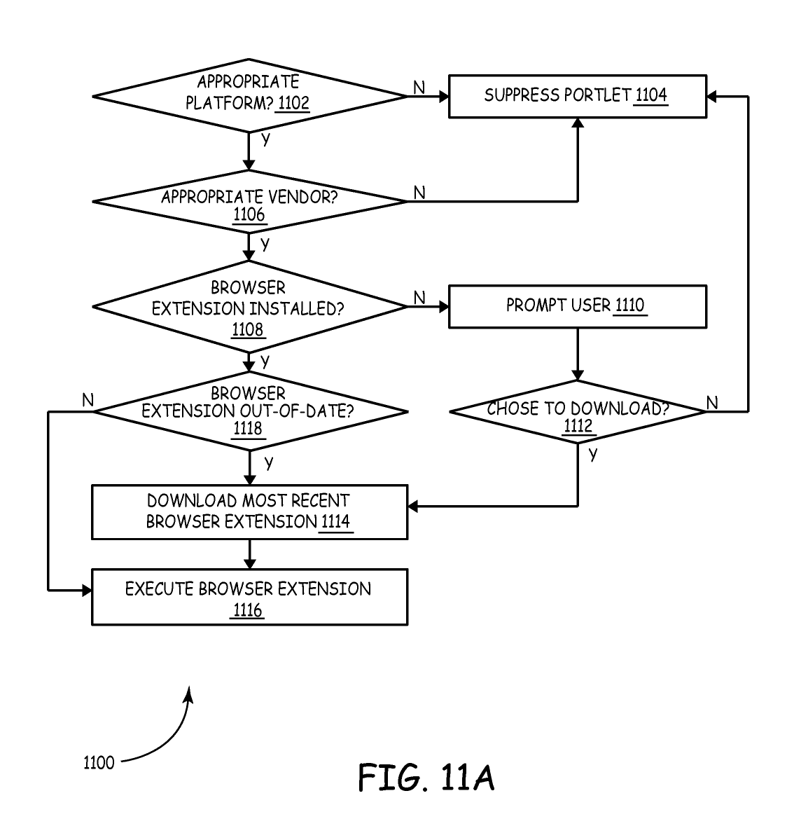

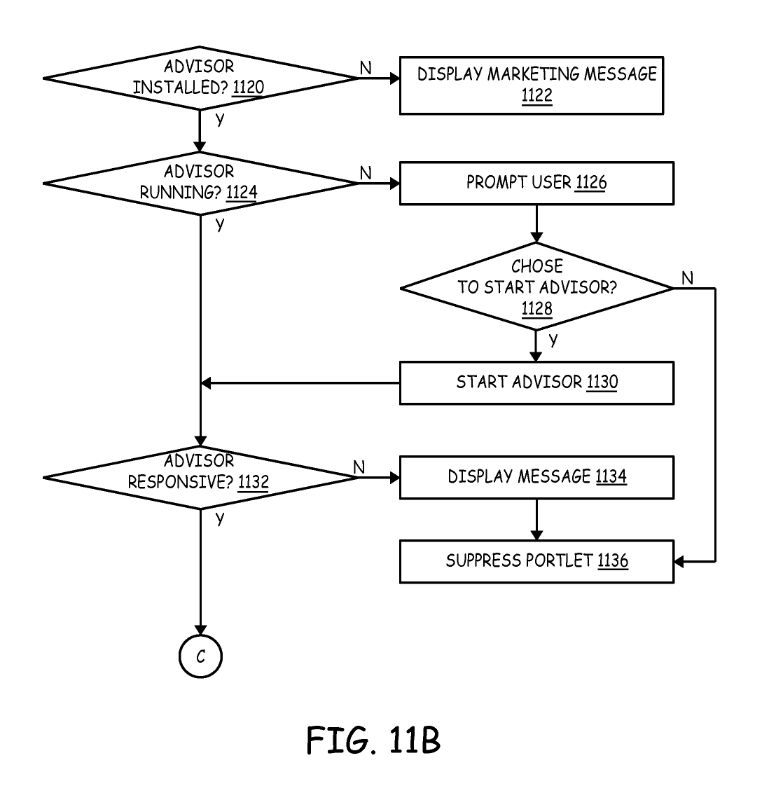

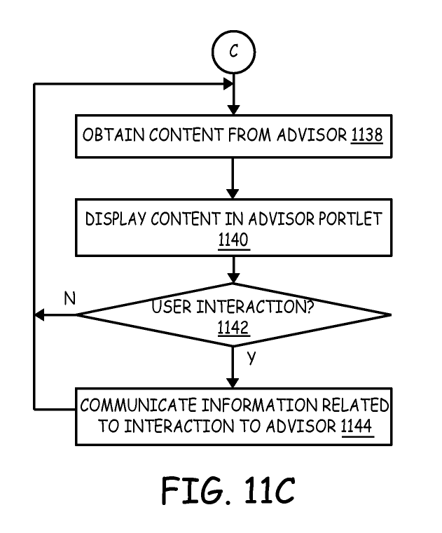

If the advisor browser extension server 811 receives a request for an advisor browser extension 808 from the computer 100 (block 1014 of FIG. 10B), the advisor browser extension server 811 supplies the advisor browser extension 808 to the requesting computer (block 1016). As described below in connection with FIGS. 11A-11C, part of the code for the advisor portlet 802 that is supplied to the Internet browser 151 is operable to submit such a request to the advisor browser extension server 811 if an appropriate version of the advisor browser extension 808 is needed.

Also, the Web portal page 804 is configured so that the user may customize some persistent aspect of the Web portal page 804 via a personalization view that is presented by the code that is used to implement the Web portal page 804. If the user personalizes some aspect of the Web portal page 804 (block 1018 of FIG. 10C), the portal server 812 saves the personalizations in the personalization store 820 so that the personalizations will be available in future sessions (block 1020).

FIGS. 11A-11C are flowcharts of one embodiment of a method 1100 of providing a user interface using an advisor portlet 802. The particular embodiment of method 1100 shown in FIG. 11 is described here as being implemented using the computer 100 of FIGS. 1-2 and the embodiment of the advisor 150 of FIGS. 3A-3H and 4-8, 9A-9C, and 10A-10C (though it is to be understood that other embodiments can be implemented in other ways). In this embodiment, the processing of method 1100 is performed by the code that is used to implement the advisor portlet 802 and the advisor browser extension 808.

The code that implements the advisor portlet 802 is executed by the Internet browser 151 after being supplied thereto from a portal server 812 (for example, as described above in connection with FIGS. 10A-10C). This code causes the Internet browser 151 to check if the Internet browser 151 is running on a platform that is appropriate for use with the advisor portlet 802 (block 1102 shown in FIG. 11A). The platform comprises the operating system (for example, the MICROSOFT VISTA operating system) and the Internet browser 151 executed by the computer 100. If the platform is not appropriate, the advisor portlet 802 is suppressed (block 1104). In one implementation of such an embodiment, whenever the advisor portlet 802 is to be suppressed, the local browser store 816 is updated to reflect that fact so that the processing associated with making that determination need not be repeated upon subsequent loads of the Web portal page 804 during that session, which will typically enable the Web portal page 804 to be loaded more quickly. When the advisor portlet 802 is suppressed, the window and other user interface artifacts associated with the advisor portlet 802 are not displayed as a part of the Web portal page 804. If the platform is appropriate, the code that implements the advisor portlet 802 checks if the vendor of the computer 100 (and/or some hardware or software used thereby) is appropriate (block 1106). For example, the advisor 150 may be designed to work with computers (and/or hardware or software used thereby) from certain vendors. If the vendor is not appropriate, the advisor portlet 802 is suppressed (block 1104). If the vendor is appropriate, the code that implements the advisor portlet 802 checks if the advisor browser extension 808 is installed on the computer 100 (block 1108).

If an advisor browser extension 808 is not installed on the computer 100, the user is prompted to download the advisor browser extension 808 (block 1110). If the user chooses to download the advisor browser extension 808 (checked in block 1112), the Internet browser 151 downloads and installs the most-recent version of the advisor browser extension 808 (block 1114) and executes the downloaded and installed advisor browser extension 808 (block 1116). The Internet browser 151 downloads the advisor browser extension 808 by sending a request to the advisor browser extension server 811, which causes the advisor browser extension server 811 to supply the advisor browser extension 808 (as described above in connection with FIG. 10B). If the user does not choose to download the advisor browser extension 808, the advisor portlet 802 is suppressed (block 1104).

If an advisor browser extension 808 is installed on the computer 100, the code that implements the advisor portlet 802 checks if the advisor browser extension 808 that is installed on the computer 100 is out-of-date (block 1118). If the installed advisor browser extension 808 is out-of-date, the Internet browser 151 downloads and installs the most-reason version of the advisor browser extension 808 (block 1114) and executes the downloaded and installed advisor browser extension 808 (block 1116). Otherwise, if the installed advisor browser extension 808 is not out-of-date, the Internet browser 151 executes the downloaded and installed advisor browser extension 808 (block 1116).

When the advisor browser extension 808 is first executed, the advisor browser extension 808 checks if the advisor 150 is installed on the computer 100 (block 1120 shown in FIG. 11B). In this embodiment, if the advisor 150 is not installed on the computer 100, the advisor browser extension 808 displays a marketing message for the advisor 150 and presents a demo therefore (block 1122). If the advisor 150 is installed on the computer 100, the advisor browser extension 808 checks if the advisor 150 is executing on the computer 100 (block 1124). If the advisor 150 is not executing on the computer 100, the advisor browser extension 808 prompts the user to start executing the advisor 150 (block 1126). If, in response to the prompt, the user chooses to start executing the advisor 150 (checked in block 1128), the advisor browser extension 808 starts executing the advisor 150 (block 1130). If the advisor 150 is executing on the computer 100, the advisor browser extension 808 checks if the advisor 150 is responsive to requests sent thereto (block 1132). In this embodiment, if the advisor 150 is non-responsive, the advisor browser extension 808 displays a message for the user indicating that fact (block 1134) and then suppresses the advisor portlet 802 (block 1136). In one implementation of such an embodiment, the extended local store 818 is updated to reflect the user's decision as to whether or not to start the advisor 150 (shown in block 1128). In such an implementation, upon subsequent loads of the Web portal page 804, the user is not prompted as to whether or not to start the advisor 150 and, instead, the extended local store 818 is consulted to determine whether the advisor 150 should be started.

If the advisor 150 is responsive, the advisor browser extension 808 obtains content from the advisor 150 (for example, status and alert information) (block 1138 shown in FIG. 11C) and then causes the obtained content to be displayed in the advisor portlet 802 portion of the Web portal page 804 (block 1140). If the Internet browser 151 interacts with the advisor portlet 802 (checked in block 1142), the advisor browser extension 808 communicates information related to such interaction to the advisor 150 for processing by the advisor 150 (block 1144). In general, the advisor 150 operates as described above in connection with FIGS. 1-2, 3A-3H, and 4-8 except the advisor 150 uses the advisor portlet 802 as a user interface therefor. For example, in such an embodiment, the advisor browser extension 808 determines which icon (or other content) displayed in the advisor portlet 802 of the Web portal page 804 the user has interacted with and communicates that fact to the advisor 150 along with any associated parameter information the user has supplied. The advisor 150 identifies and executes an appropriate action handler to process such user input as described above.

The use of a Web portal and web portal page to present a user interface for a program that is executing locally on a computer can be used in other applications and for other types of local programs.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method comprising:
automatically receiving information related to a heterogeneous group of resources associated with a computing device;
automatically disabling, for each of the heterogeneous group of resources, a respective notification mechanism otherwise used at the computing device to provide notifications about any of the information;
automatically filtering the information in connection with generating system-administration content for display; and
displaying a shared user-interface object that is used to display system-administration content associated with a plurality of the resources.

2. The method of claim 1, wherein the shared user-interface object is used to display a plurality of blocks of content associated with a plurality of the resources, each of the blocks of content including content indicative of a task to be performed that is associated with a respective resource and causing software operable to perform the task to be executed in response to receiving user input associated with the respective content.

3. The method of claim 2, wherein a reference-by-name scheme is used to display the system-administration content in the shared user-interface object and to handle user input related to content displayed in the shared user-interface object.

4. The method of claim 1, further comprising updating the system-administration content displayed in the shared user-interface object.

5. The method of claim 1, wherein the heterogeneous group of resources comprises resources related to at least one of operating system software, application software, hardware resources, and network resources.

6. The method of claim 5, wherein network resources comprises at least one of a network resource communicatively coupled to the device using a local area network and a network resource communicatively coupled to the device using a wide area network.

7. The method of claim 1, further comprising monitoring at least one of:
interactions of a user with the shared user-interface object, operation of the computing device, and use of the heterogeneous group of resources by the computing device.

8. The method of claim 7, wherein the information is automatically filtered based at least in part on information derived from monitoring.

9. The method of claim 1, wherein the shared user-interface object is used to display content that comprises product offerings related to one or more of the resources or the computing device.

10. The method of claim 1, further comprising prioritizing the information in connection with generating the system-administration content for display.

11. The method of claim 1, wherein the shared user-interface object comprises a portion of a web page that is displayed in a browser.

12. The method of claim 11, wherein the web page comprises a web portal page and the portion of the web page comprises a portlet.

13. A device comprising:
at least one processor to execute software;
a storage medium communicatively coupled to the processor from which the processor reads at least a portion of the software for execution thereby;
wherein the software comprises a system administration application, the system administration application comprising a plurality of user-interface modules;
wherein the system administration application is operable to cause the processor to display a shared user-interface object therefor;
wherein each of the user-interface modules is operable to cause the processor to automatically update a block of content with current information received from at least one resource and display the updated block of content in the shared user-interface object; and
wherein the system administration application is operable to cause the processor to execute software operable to perform a system administration task associated with at least one block of content displayed in the shared user-interface object in response to user input received when the at least block of content is displayed in the shared user-interface object.

14. The device of claim 13, wherein the shared user-interface object has associated therewith a plurality of states including an open state and a minimized state.

15. The device of claim 13, further comprising navigating between different pages of content in response to user input received by the shared user-interface object, each of page of content comprising at least one block of content.

16. The device of claim 13, wherein the content is logically arranged in pillars comprising a pillar related to the health and security of the device, a pillar related to alerts for the device and the resources used therewith, and a pillar related to help information.

17. The device of claim 13, wherein the system administration application comprises a plurality of plug-ins.

18. The device of claim 17, wherein at least some of the plug-ins comprise the user-interface modules.

19. The device of claim 17, wherein the at least some of the plug-ins are operable to receive information from at least one resource.

20. The device of claim 17, wherein the system administration application is operable to load and unload at least some of the plug-ins as needed.

21. The device of claim 13, wherein the resource comprises at least one of a network resource communicatively coupled to the device using a local area network and a network resource communicatively coupled to the device using a wide area network.

22. A program product comprising a processor-readable medium on which program instructions are embodied, wherein the program instructions are operable, when executed by at least one programmable processor included in a device, to cause the device to:
automatically receive information from a heterogonous group of resources related to the device, wherein the resources comprise operating system software, application software, and product offerings; and
display a shared user-interface object that is used to display content associated with the resources; and
wherein the shared user-interface object is used to display content indicative of a system administration task and wherein the program instructions are operable, when executed by the at least one programmable processor included in the device, to cause the device to execute software that is operable to perform the system administration task when predetermined user input associated with content is received; and
wherein the shared user-interface object is used to display content associated with product offerings.

23. The program product of claim 22, wherein the shared user-interface object is used to display content arranged into logical pages, each page comprising at least one content block.

24. The program product of claim 22, wherein the shared user-interface object is used to display content for a user to purchase products related to the device.

25. The program product of claim 22, wherein the shared user-interface object is used to display content associated with performing at least one of price comparisons for a product related to the device and product comparisons for products related to the device.

26. The program product of claim 22, wherein the shared user-interface object comprises a portion of a web page that is displayed in a browser.

27. A method comprising:
automatically receiving information related to a heterogeneous group of resources associated with a computing device;
displaying a shared user-interface object that is used to display content associated with a plurality of the resources associated with the computing device, wherein at least some of the content is indicative of a system administration task to be performed and wherein at least some of the content is derived from at least some of the information;
causing the system administration task to be performed when predetermined user input associated with the at least some content is received;
monitoring at least one of: interactions of a user with the shared user-interface object, operation of the computing device, and use of the heterogeneous group of resources by the computing device, wherein monitoring information is generated by the monitoring; and
communicating at least some of the monitoring information to at least one of the resources associated with the computing device for use in generating information to be communicated to the computing device that is derived from the at least some of the monitoring information.

28. The method of claim 27, wherein the at least one of the resources to which the at least some of the monitoring information is communicated comprises at least one of a remote user information warehouse resource and local behavior detection and monitoring software.

29. The method of claim 27, wherein the information derived from at least some of the monitoring information comprises at least one of information about a software update, information about a product offering, and information about a content update.

30. A system for presenting a user interface for a local program executing on a computing device, the system comprising:
at least one remote server to supply a web page; and
a computing device operable to execute the local program and a browser, the computing device communicatively coupled to the remote server;
wherein the computing device is operable execute the local program outside of an environment associated with the browser;
wherein the remote server is operable to supply the web page to the browser; and
wherein a portion of the web page is operable to display the user interface for the local program in the browser.

31. The system of claim 30, wherein the portion of the web page that is operable to display the user interface for the local program in the browser comprises a portlet for the local program.

32. The system of claim 30, wherein the browser uses a browser extension to communicate directly with the local program without having to communicate with the remote server, wherein the browser extension is operable to tunnel through the environment associated with the browser.

33. The system of claim 32, wherein at least one server is operable to supply the browser extension to the computing device when needed.

34. The system of claim 30, wherein at least a portion of user input associated with the portion of the web page that is operable to display the user interface for the local program is received by the browser and is provided thereby to the local program for processing.

35. The system of claim 30, wherein the portion of the web page that is operable to display the user interface for the local program is dynamically updated based on communicating with the local program.

36. The system of claim 30, wherein the remote server is operable to store personalization information in a store associated therewith.

37. The system of claim 30, wherein the local program comprises a system administration application.

38. The system of claim 37, wherein the system administration application automatically disables, for each of a heterogeneous group of resources with which the system administration interacts, a respective notification mechanism otherwise used at the computing device to provide notifications about the respective resource and wherein the system administration application automatically filters information received from the heterogeneous group of resources in connection with generating system-administration content for display using the user interface.

39. A method for presenting a user interface for a local program executing on a computing device, the method comprising:
accessing a web portal using a browser executing on the computing device;
receiving, at the browser, a web portal page for the web portal, wherein a portion of the web portal page is operable to display the user interface for the local program in the browser;
communicating information from the local program executing on the computing device to the browser; and
updating the portion of the web portal page that is operable to display the user interface for the local program in the browser using at least a portion of the information communicated to the browser from the local program;
wherein the local program executes on the computing device outside of an environment associated with the browser.

40. The method of claim 39, further comprising:
receiving, by the browser, user input associated with the portion of the web portal page that is operable to display the user interface for the local program;
communicating from the browser to the local program at least a portion the user input associated with the portion of the web portion page that is operable to display the user interface for the local program; and
processing by the local program the at least a portion of the user input associated with the portion of the web portion page that is operable to display the user interface for the local program.

41. The method of claim 40, further comprising receiving at the computing device a browser extension associated with the portion of the web portal page that is operable to display the user interface for the local program in the browser, wherein the browser extension is operable to tunnel through the environment associated with the browser in order to communicate the information from the local program executing on the computing device to the browser and to communicate from the browser to the local program the at least a portion the user input associated with the portion of the web portion page that is operable to display the user interface for the local program.

42. The method of claim 39, further comprising receiving at a server associated with the web portal a personalization associated with the portion of the web portal page that is operable to display the user interface for the local program and storing the personalization at the server, wherein the personalization is used to generate the web portal page in the future.

43. The method of claim 39, wherein the local program comprises a system administration application.
